(19) United States
(12) Patent Application Publication
(10) Pub. No.: US 2025/0220719 A1
(43) Pub. Date: Jul. 3, 2025

(54) MULTIPLEXING RANDOM ACCESS TRANSMISSIONS WITH DIFFERENT SPATIAL FILTERS

(71) Applicant: QUALCOMM INCORPORATED, San Diego, CA (US)

(72) Inventors: Hung Dinh Ly, San Diego, CA (US); Kexin Xiao, Shanghai (CN); Krishna Kiran Mukkavilli, San Diego, CA (US)

(21) Appl. No.: 18/843,654

(22) PCT Filed: Apr. 28, 2022
(86) PCT No.: PCT/CN2022/089772

§ 371 Date: Sep. 3, 2024

(51) Int. Cl. H04W 74/0833

(52) U.S. Cl. CPC H04W 74/0833

(57) ABSTRACT

Methods, systems, and devices for wireless communication are described. In some systems, a first network node may transmit a first synchronization signal block (SSB) associated with a first spatial filter and a first set of random access occasions within a respective instance of a random access occasion window and a second SSB associated with a second spatial filter and a second set of random access occasions that overlap in time with the first set of random access occasions during the random access occasion window. A second network node may receive the SSBs and transmit instances of a random access message during one or more instances of the random access occasion window using the first spatial filter, the second spatial filter, or both based on a rule for random access message multiplexing when random access occasions associated with different spatial filters to be used for random access messages overlap in time.

### CROSS REFERENCE

The present application is a 371 national stage filing of International PCT Application No. PCT/CN2022/089772 by Ly et al. entitled “MULTIPLEXING RANDOM ACCESS TRANSMISSIONS WITH DIFFERENT SPATIAL FILTERS,” filed Apr. 28, 2022, which is assigned to the assignee hereof, and which is expressly incorporated by reference in its entirety herein.

### INTRODUCTION

The following generally relates to wireless communication relating to multiplexing random access transmissions with spatial filters.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support multiplexing random access transmissions with different spatial filters. For example, the described techniques provide for a network node to transmit one or more instances of a random access message within one or more instances of a random access occasion using a same spatial filter or different spatial filters based on a rule set for random access multiplexing when random access occasions associated with different spatial filters to be used for random access message transmissions overlap in at least one of time or frequency. The network node may, in some aspects, receive a message that indicates the rule set. The network node may receive a first synchronization signal block (SSB) associated with a first spatial filter and with a first set of one or more random access occasions within a respective instance of a random access occasion window. For example, the first SSB may be mapped or linked to the first set of one or more random access occasions in the respective instance of the random access occasion window, in one or more other instances of the random access window, or both. The network node may receive a second SSB associated with a second spatial filter and with a second set of one or more random access occasions. The second set of one or more random access occasions may overlap in at least one of time or frequency with the first set of one or more random access occasions in the respective instance of the random access occasion window.

The network node may transmit one or more first instances (e.g., repetitions) of a random access message using the first spatial filter and the first set of one or more random access occasions during a first instance of the random access occasion window. Techniques, systems, and devices described herein provide for the network node to transmit one or more additional instances of the random access message during one or more additional instances of the random access occasion window using one or more of the first spatial filter and the first set of one or more random access occasions or the second spatial filter and the second set of one or more random access occasions. The network node may select one or both of the first and second spatial filters and corresponding sets of random access occasions based on the rule set received via the message or configured at the network node. The network node may thereby transmit multiple instances of a random access message using different spatial filters associated with random access occasions that overlap in time, frequency, or both based on the rule set.

A method is described. The method may include receiving a first SSB associated with a first spatial filter and with a first set of one or more random access occasions within a respective instance of a random access occasion window, receiving a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window, transmitting, during a first instance of the random access occasion window, one or more first instances of a random access message using the first spatial filter and the first set of one or more random access occasions, and transmitting, during one or more additional instances of the random access occasion window, one or more additional instances of the random access message using, based on a rule set for random access message multiplexing when random access occasions associated with different spatial filters to be used for random access message transmissions overlap in at least one of time or frequency, one or more of: the first spatial filter and the first set of one or more random access occasions, or the second spatial filter and the second set of one or more random access occasions.

A network node is described. The network node may include a memory, and at least one processor. The at least one processor may be configured to receive a first SSB associated with a first spatial filter and with a first set of one or more random access occasions within a respective instance of a random access occasion window, receive a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window, transmit, during a first instance of the random access occasion window, one or more first instances of a random access message using the first spatial filter and the first set of one or more random access occasions, and transmit, during one or more additional instances of the random access occasion window, one or more additional instances of the random access message using, based on a rule set for random access message multiplexing when random access occasions associated with different spatial filters to be used for random access message transmissions overlap in at least one of time or frequency: one or more of the first spatial filter and the first set of one or more random access occasions, or the second spatial filter and the second set of one or more random access occasions.

Another apparatus is described. The apparatus may include means for receiving a first SSB associated with a first spatial filter and with a first set of one or more random access occasions within a respective instance of a random access occasion window, means for receiving a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window, means for transmitting, during a first instance of the random access occasion window, one or more first instances of a random access message using the first spatial filter and the first set of one or more random access occasions, and means for transmitting, during one or more additional instances of the random access occasion window, one or more additional instances of the random access message using, based on a rule set for random access message multiplexing when random access occasions associated with different spatial filters to be used for random access message transmissions overlap in at least one of time or frequency, one or more of: the first spatial filter and the first set of one or more random access occasions, or the second spatial filter and the second set of one or more random access occasions.

A non-transitory computer-readable medium storing code is described. The code may include instructions executable by a processor to receive a first SSB associated with a first spatial filter and with a first set of one or more random access occasions within a respective instance of a random access occasion window, receive a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window, transmit, during a first instance of the random access occasion window, one or more first instances of a random access message using the first spatial filter and the first set of one or more random access occasions, and transmit, during one or more additional instances of the random access occasion window, one or more additional instances of the random access message using, based on a rule set for random access message multiplexing when random access occasions associated with different spatial filters to be used for random access message transmissions overlap in at least one of time or frequency, one or more of: the first spatial filter and the first set of one or more random access occasions, or the second spatial filter and the second set of one or more random access occasions.

In some examples of the method, apparatuses, and non-transitory computer-readable medium described herein, transmitting the one or more additional instances of the random access message may include operations, features, means, or instructions for transmitting the one or more additional instances of the random access message using the first spatial filter and the first set of one or more random access occasions based on the rule set, where the rule set may be that each instance of the random access message may be to be transmitted using a same spatial filter.

In some examples of the method, apparatuses, and non-transitory computer-readable medium described herein, transmitting the one or more additional instances of the random access message may include operations, features, means, or instructions for transmitting the one or more additional instances of the random access message using at least the second spatial filter and at least the second set of one or more random access occasions based on the rule set, where the rule set may be that different instances of the random access message may be to be transmitted using different spatial filters.

In some examples of the method, apparatuses, and non-transitory computer-readable medium described herein, multiplexing, in accordance with a time domain multiplexing (TDM) pattern specified by the rule set, transmissions of the one or more first instances of the random access message using the first spatial filter with the one or more additional instances of the random access message using the first spatial filter and the second spatial filter.

In some examples of the method, apparatuses, and non-transitory computer-readable medium described herein, transmitting the one or more additional instances of the random access message may continue until a sum of a first quantity of the one or more first instances of the random access message associated with the first spatial filter and a second quantity of the one or more additional instances of the random access message associated with the second spatial filter equals a total quantity.

Some examples of the method, apparatuses, and non-transitory computer-readable medium described herein may further include operations, features, means, or instructions for receiving a message that indicates the first quantity and the second quantity, where the message includes a radio resource control (RRC) message or a system information block (SIB).

Some examples of the method, apparatuses, and non-transitory computer-readable medium described herein may further include operations, features, means, or instructions for receiving a message that indicates the total quantity, where the message includes an RRC message or a SIB.

In some examples of the method, apparatuses, and non-transitory computer-readable medium described herein, transmitting the one or more first instances of the random access message may include transmitting, in accordance with the rule set, the first quantity of the one or more first instances of the random access message associated with the first spatial filter and transmitting the one or more additional instances of the random access message may include transmitting, in accordance with the rule set, the second quantity of the one or more additional instances of the random access message associated with the second spatial filter after transmission of the first quantity of the one or more first instances of the random access message.

In some examples of the method, apparatuses, and non-transitory computer-readable medium described herein, transmitting the one or more first instances of the random access message may include transmitting, in accordance with an interleaving pattern specified by the rule set, the first quantity of instances of the random access message associated with the first spatial filter and transmitting the one or more additional instances of the random access message may include transmitting, in accordance with the interleaving pattern specified by the rule set, the second quantity of the one or more additional instances of the random access message associated with the second spatial filter, the one or more additional instances of the random access message interleaved with the one or more first instances of the random access message in time based on interleaving pattern.

In some examples of the method, apparatuses, and non-transitory computer-readable medium described herein, the first quantity may equal the second quantity. In some examples of the method, apparatuses, and non-transitory computer-readable medium described herein, the first quantity and the second quantity may be different.

Some examples of the method, apparatuses, and non-transitory computer-readable medium described herein may further include operations, features, means, or instructions for receiving a message that indicates the rule set and a pattern specified by the rule set, the pattern including a random access message multiplexing pattern for transmitting the first quantity of instances of the random access message associated with the first spatial filter and the second quantity of instances of the random access message associated with the second spatial filter, where the message includes an RRC message or a SIB.

In some examples of the method, apparatuses, and non-transitory computer-readable medium described herein, transmitting the one or more first instances of the random access message may include operations, features, means, or instructions for transmitting the one or more first instances of the random access message using the first spatial filter and the first set of one or more random access occasions based on a selection of the first spatial filter from a set of multiple spatial filters including at least the first spatial filter and the second spatial filter based on a measurement of the first SSB, based on the rule set, or both.

In some examples of the method, apparatuses, and non-transitory computer-readable medium described herein, the first set of one or more random access occasions and the second set of one or more random access occasions may overlap partially or fully in at least one of time or frequency during the respective instance of the random access occasion window.

A method is described. The method may include transmitting a message that indicates a rule set for random access message multiplexing by a second network node when random access occasions associated with different spatial filters to be used for random access messages overlap in at least one of time or frequency, transmitting a first SSB associated with a first spatial filter and with a first set of one or more random access occasions within a respective instance of a random access occasion window, transmitting a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window, and monitoring, during one or more instances of the random access occasion window, for one or more instances of a random access message using one or more of: the first spatial filter and the first set of one or more random access occasions, or the second spatial filter and the second set of one or more random access occasions.

A first network node is described. The first network node may include a memory and at least one processor coupled to the memory. The at least one processor may be configured to transmit a message that indicates a rule set for random access message multiplexing by a second network node when random access occasions associated with different spatial filters to be used for random access messages overlap in at least one of time or frequency, transmit a first SSB associated with a first spatial filter and with a first set of one or more random access occasions within a respective instance of a random access occasion window, transmit a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window, and monitor, during one or more instances of the random access occasion window, for one or more instances of a random access message using one or more of: the first spatial filter and the first set of one or more random access occasions, or the second spatial filter and the second set of one or more random access occasions.

Another apparatus is described. The apparatus may include means for transmitting a message that indicates a rule set for random access message multiplexing by a second network node when random access occasions associated with different spatial filters to be used for random access messages overlap in at least one of time or frequency, means for transmitting a first SSB associated with a first spatial filter and with a first set of one or more random access occasions within a respective instance of a random access occasion window, means for transmitting a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window, and means for monitoring, during one or more instances of the random access occasion window, for one or more instances of a random access message using one or more of: the first spatial filter and the first set of one or more random access occasions or the second spatial filter and the second set of one or more random access occasions.

A non-transitory computer-readable medium storing code is described. The code may include instructions executable by a processor to transmit a message that indicates a rule set for random access message multiplexing by a second network node when random access occasions associated with different spatial filters to be used for random access messages overlap in at least one of time or frequency, transmit a first SSB associated with a first spatial filter and with a first set of one or more random access occasions within a respective instance of a random access occasion window, transmit a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window, and monitor, during one or more instances of the random access occasion window, for one or more instances of a random access message using one or more of: the first spatial filter and the first set of one or more random access occasions, or the second spatial filter and the second set of one or more random access occasions.

In some examples of the method, apparatuses, and non-transitory computer-readable medium described herein, transmitting the message may include operations, features, means, or instructions for transmitting an indication of the rule set for random access multiplexing to be performed by the second network node, where the rule set may be that the second network node transmits each instance of the random access message using a same spatial filter.

In some examples of the method, apparatuses, and non-transitory computer-readable medium described herein, transmitting the message may include operations, features, means, or instructions for transmitting an indication of the rule set for random access multiplexing to be performed by the second network node, where the rule set may be that the second network node transmits instances of the random access message using different spatial filters.

In some examples of the method, apparatuses, and non-transitory computer-readable medium described herein, the rule set indicates a TDM pattern for multiplexing transmissions of the one or more instances of the random access message using the first spatial filter and the second spatial filter.

In some examples of the method, apparatuses, and non-transitory computer-readable medium described herein, transmitting the message may include operations, features, means, or instructions for transmitting an indication of a parameter for random access multiplexing, where the parameter indicates a first quantity of instances of the random access message associated with the first spatial filter and a second quantity of instances of the random access message associated with the second spatial filter.

In some examples of the method, apparatuses, and non-transitory computer-readable medium described herein, the first quantity may equal the second quantity. In some examples of the method, apparatuses, and non-transitory computer-readable medium described herein, the first quantity and the second quantity may be different.

In some examples of the method, apparatuses, and non-transitory computer-readable medium described herein, transmitting the message may include operations, features, means, or instructions for transmitting an indication of a parameter for random access multiplexing, where the parameter indicates a total quantity of the one or more instances of the random access message for a set of multiple spatial filters including at least the first spatial filter and the second spatial filter.

In some examples of the method, apparatuses, and non-transitory computer-readable medium described herein, transmitting the message may include operations, features, means, or instructions for transmitting an indication of the rule set for random access multiplexing by the second network node, where the rule set may be that the second network node transmits a first quantity of instances of the random access message associated with the first spatial filter and a second quantity of instances of the random access message associated with the second spatial filter after transmitting the first quantity of instances of the random access message.

In some examples of the method, apparatuses, and non-transitory computer-readable medium described herein, transmitting the message may include operations, features, means, or instructions for transmitting an indication of the rule set for random access multiplexing by the second network node, where the rule set may be that the second network node transmits a first quantity of instances of the random access message associated with the first spatial filter and a second quantity of instances of the random access message associated with the second spatial filter in accordance with an interleaving pattern specified by the rule set.

In some examples of the method, apparatuses, and non-transitory computer-readable medium described herein, transmitting the message may include operations, features, means, or instructions for transmitting an RRC message or a SIB that indicates the rule set for random access message multiplexing when random access occasions associated with different spatial filters to be used for random access messages overlap partially or fully in at least one of time or frequency.

### BRIEF DESCRIPTION OF THE DRAWINGS

FIG. 1 illustrates an example of a wireless communications system that supports multiplexing random access transmissions with different spatial filters in accordance with one or more aspects of the present disclosure.

FIG. 2 illustrates an example of a wireless communications system that supports multiplexing random access transmissions with different spatial filters in accordance with one or more aspects of the present disclosure.

FIGS. 3-5 illustrate examples of random access occasion configurations that support multiplexing random access transmissions with different spatial filters in accordance with one or more aspects of the present disclosure.

FIGS. 6 and 7 illustrate examples of random access message repetition diagrams that support multiplexing random access transmissions with different spatial filters in accordance with one or more aspects of the present disclosure.

FIGS. 8-13 illustrate examples of random access multiplexing patterns that support multiplexing random access transmissions with different spatial filters in accordance with one or more aspects of the present disclosure.

FIG. 14 illustrates an example of a process flow that supports multiplexing random access transmissions with different spatial filters in accordance with one or more aspects of the present disclosure.

FIGS. 15 and 16 show block diagrams of devices that support multiplexing random access transmissions with different spatial filters in accordance with one or more aspects of the present disclosure.

FIG. 17 shows a block diagram of a communications manager that supports multiplexing random access transmissions with different spatial filters in accordance with one or more aspects of the present disclosure.

FIG. 18 shows a diagram of a system including a device that supports multiplexing random access transmissions with different spatial filters in accordance with one or more aspects of the present disclosure.

FIGS. 19 and 20 show block diagrams of devices that support multiplexing random access transmissions with different spatial filters in accordance with one or more aspects of the present disclosure.

FIG. 21 shows a block diagram of a communications manager that supports multiplexing random access transmissions with different spatial filters in accordance with one or more aspects of the present disclosure.

FIG. 22 shows a diagram of a system including a device that supports multiplexing random access transmissions with different spatial filters in accordance with one or more aspects of the present disclosure.

FIGS. 23 through 26 show flowcharts illustrating methods that support multiplexing random access transmissions with different spatial filters in accordance with one or more aspects of the present disclosure.

### DETAILED DESCRIPTION

Some wireless communications systems include network nodes that perform a random access procedure to establish or re-establish a connection. A network node, which may be referred to as a node, a network entity, or a wireless node, may be a base station, a user equipment (UE), a network controller, an apparatus, a device, a computing system, one or more components, and/or another suitable processing entity configured to perform any of the techniques described herein. To initiate a random access procedure (e.g., a two-step or four-step random access procedure), a first network node may transmit a first random access message containing a random access preamble to a second network node via a random access channel (e.g., a physical random access channel (PRACH)). The first network node may transmit the message via a random access occasion, which may include a set of one or more time and frequency resources. The random access occasion may be associated with a spatial filter (e.g., a beam). For example, the random access occasion may be linked to or mapped to a synchronization signal block (SSB) that is transmitted and/or received using the spatial filter. The random access occasion and the SSB may be linked based on one or more configurations for random access associations. The first network node may receive multiple SSBs or other reference signals from the second network node using a respective beam for each SSB. The first network node may select an SSB based on a signal strength measurement (e.g., a reference signal received power (RSRP)) of the SSB exceeding a threshold value. The first network node may use the spatial filter and random access occasion associated with the selected SSB to receive the random access message.

In some aspects, the first network node may transmit one or more instances of the random access message, which may be referred to as random access repetitions or PRACH repetitions. Each instance of the random access message may be a repetition or a duplicate version of each other instance. For example, each instance may include the same preamble or other random access information and may be transmitted in different time resources, different frequency resources, or both to improve throughput and communication reliability. The first network node may select one or more SSBs to use for transmitting the quantity of instances of the random access message. The selected SSBs may be associated with a same or different spatial filter. In some aspects, the selected SSBs may map to at least two random access occasions that overlap in time (e.g., frequency division multiplexed (FDM) random access occasions), frequency, or both. However, the first network node may not support multiple transmissions in different directions (e.g., using different spatial filters) concurrently or in partially overlapping time resources. As such, the first network node may not support transmission of each scheduled instance of the random access message using each of the selected spatial filters. Techniques for determining which spatial filter and corresponding random access occasion the first network node may use at a given time may reduce ambiguity, reduce latency, and improve communication reliability and throughput.

Techniques described herein provide for a first network node to multiplex, in time, random access message instances associated with one or more different spatial filters. For example, the first network node may follow a set of one or more rules, which may be referred to as a rule set, pertaining to random access message multiplexing when random access messages associated with different spatial filters are to be used for random access message transmissions overlap in one of time or frequency. If the first network node is scheduled to transmit two or more instances of a random access message based on two or more selected SSBs that are associated with different spatial filters and map to random access occasions that overlap in time, the first network node may follow the rule set for determining how to transmit the scheduled instances. The rule set may be defined (e.g., pre-configured or pre-defined in a standard) or indicated to the first network node via a message, such as a system information block (SIB), a radio resource control (RRC) message, or some other control information from a second network node.

The rule set may be for the first network node to transmit each scheduled instance of the random access message using a same spatial filter. Additionally or alternatively, the rule set may be for the first network node to transmit the scheduled instances of the random access message using different spatial filters according to a multiplexing pattern specified by the rule set. The multiplexing pattern may indicate that a first subset of instances may be transmitted via a first subset of random access occasions associated with a first spatial filter, and other subsets of instances of the random access message may subsequently be transmitted via a second subset of random access occasions associated with a second spatial filter after the first subset of instance are transmitted. Additionally or alternatively, the multiplexing pattern may indicate that the instances of the random access message may be transmitted in an interleaved or alternating pattern that alternates between use of a first spatial filter and one or more other spatial filters. In some aspects, the multiplexing pattern, the rule set, or both may be indicated to the first network node via a message (e.g., a SIB or an RRC message) or defined at the first network node.

The first network node may determine a quantity of instances of a random access message that may be transmitted using each spatial filter. The respective quantities for each spatial filter may be defined or indicated to the first network node via a message (e.g., a SIB or RRC message). The message may indicate a total quantity of instances across multiple spatial filters, or the message may indicate respective quantities separately for each spatial filter. If the message indicates the total quantity of instances, the first network node may determine the respective quantities of instances per spatial filter based on one or more measurements or parameters associated with the first network node. The first network node may thereby utilize a rule set to determine one or more spatial filters to apply for transmitting one or more instances (e.g., repetitions) of a random access message.

Aspects of the disclosure are initially described in the context of wireless communications systems. Additional aspects of the disclosure are described with reference to random access occasion configurations, random access message repetition diagrams, random access multiplexing patterns, and process flows. Aspects of the disclosure are further illustrated by and described with reference to apparatus diagrams, system diagrams, and flowcharts that relate to multiplexing random access transmissions with different spatial filters.

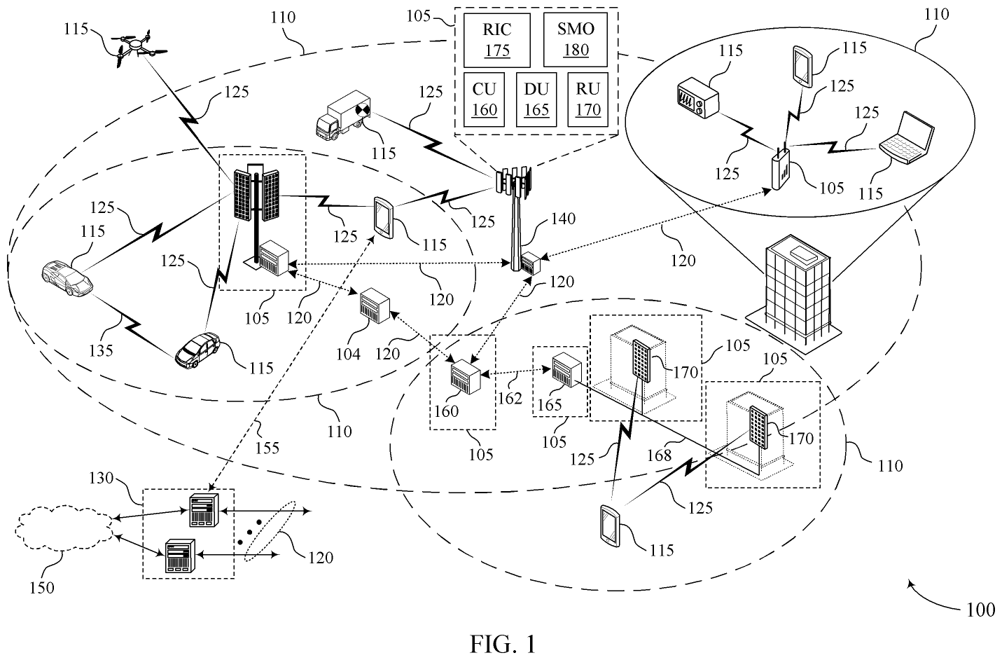

FIG. 1 illustrates an example of a wireless communications system 100 that supports multiplexing random access transmissions with different spatial filters in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another over a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (LAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support multiplexing random access transmissions with different spatial filters as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some aspects, the wireless communications system 100 may include network entities 105 or UEs 115 that support concurrent communications via carriers associated with multiple carrier bandwidths. In some aspects, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some aspects, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some aspects, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be able to communicate directly with other UEs 115 over a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some aspects, one or more UEs 115 in such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some aspects, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some aspects, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some aspects, a network node, such as a UE 115 or a network entity 105, in the wireless communications system 100 may transmit one or more instances or repetitions of a random access message. The network node may transmit the one or more instances of the random access message within one or more instances of a random access occasion using a same spatial filter or different spatial filters based on a rule set for random access multiplexing when random access occasions associated with different spatial filters to be used for random access message transmissions overlap in at least one of time or frequency. The network node may, in some aspects, receive a message that indicates the rule set. The network node may receive a first SSB associated with a first spatial filter and with a first set of one or more random access occasions within a respective instance of a random access occasion window. For example, the first SSB may be mapped or linked to the first set of one or more random access occasions in the respective instance of the random access occasion window, in one or more other instances of the random access window, or both. The network node may receive a second SSB associated with a second spatial filter and with a second set of one or more random access occasions. The second set of one or more random access occasions may overlap in at least one of time or frequency with the first set of one or more random access occasions in the respective instance of the random access occasion window.

The network node may transmit one or more first instances (e.g., repetitions) of a random access message using the first spatial filter and the first set of one or more random access occasions during a first instance of the random access occasion window. Techniques, systems, and devices described herein provide for the network node to transmit one or more additional instances of the random access message during one or more additional instances of the random access occasion window using one or more of the first spatial filter and the first set of one or more random access occasions or the second spatial filter and the second set of one or more random access occasions. The network node may select one or both of the first and second spatial filters and corresponding sets of random access occasions based on the rule set received via the message or configured at the network node. The network node may thereby transmit multiple instances of a random access message using different spatial filters associated with random access occasions that overlap in time, frequency, or both based on the rule set.

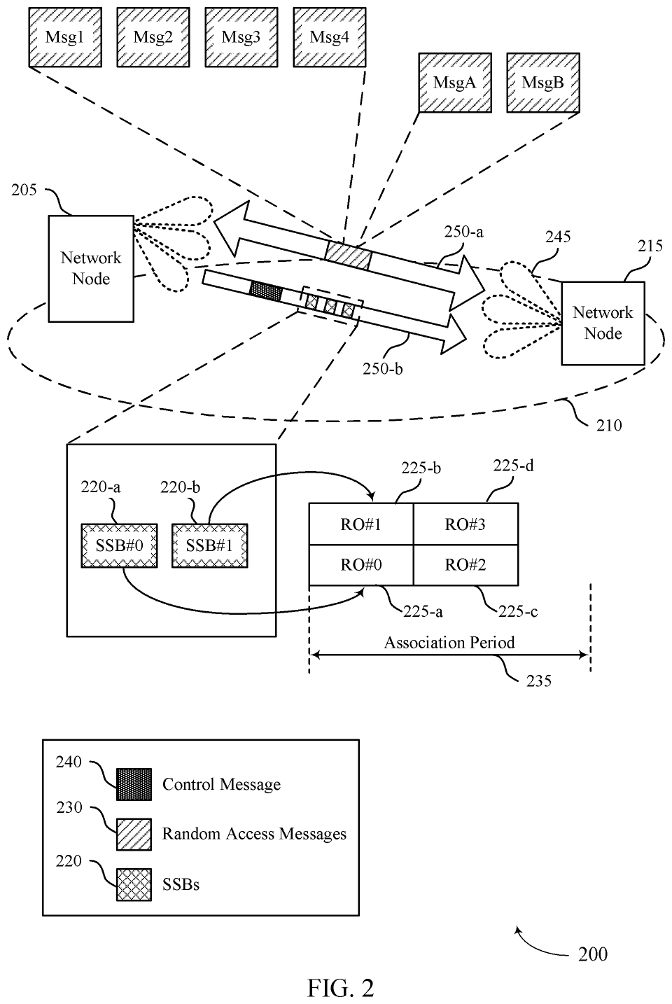

FIG. 2 illustrates an example of a wireless communications system 200 that supports multiplexing random access transmissions with different spatial filters in accordance with one or more aspects of the present disclosure. The wireless communications system 200 may implement or be implemented by aspects of the wireless communications system 100 as described with reference to FIG. 1. For example, the wireless communications system 200 may include a network node 205 and a network node 215, which may represent examples of a base station 140, a UE 115, a network entity 105, or some other network nodes as described with reference to FIG. 1. The network node 205 may communicate with the network node 215 within a geographic coverage area 210 and via one or more communication links 250 (e.g., communication links 250-a and 250-b, which may each correspond to a respective channel or frequency band). The network node 205 and the network node 215 may support beamformed communications using one or more beams 245.

The network node 205 and the network node 215 may perform a random access procedure (e.g., a random access channel (RACH) procedure) prior to establishing an RRC connection. In some aspects, the network nodes may perform the random access procedure to setup an initial RRC connection, to re-establish a previous RRC connection, to perform a handover (e.g., a RACH procedure to the target or destination cell), for downlink data arrival (e.g., initiated by a physical downlink control channel (PDCCH) order), for uplink data arrival during an RRC connected state when no physical uplink control channel (PUCCH) resources are available, in response to a scheduling request failure, to transition between RRC connected and inactive states, for beam recovery, or any combination thereof. The random access procedure may be a two-step or a four-step random access procedure. These random access procedures may be contention-based random access (CBRA) or contention-free random access (CFRA) depending on the type of the procedure and the random access use case.

As part of the random access procedure, the network node 205 and the network node 215 may exchange one or more random access messages 230 (e.g., handshake messages). In a four-step random access procedure, the random access messages 230 may include a msg1, a msg2, a msg3, and a msg4. The msg1 may include a RACH preamble or a sequence that may carry information, such as a device identifier (ID) (e.g., a UE ID). The purpose of the preamble may be to provide an indication, to the network node 205, of the presence of a random access attempt (e.g., from the network node 215). The preamble may also allow the network node 205 to determine a delay (e.g., a timing delay) between the network node 205 and the network node 215. The network node 215 may transmit the msg1 to the network node 205 on a PRACH, for example.

Upon receiving the msg1, the network node 205 may respond appropriately with the msg2 (e.g., a random access response (RAR)). The network node 205 may transmit the msg2 to the network node 215 on a physical downlink shared channel (PDSCH) or a PDCCH. In some aspects, the msg2 may have a same or a different configuration (format) compared to the msg1. The msg2 may carry information for the network node 215, where the information is determined by the network node 205 and is based on information carried in the msg1. For example, the information in the msg2 may include an index of a preamble sequence detected and for which the response is valid, a timing advance determined based on the preamble sequence detected, an uplink grant indicating time and frequency resources for the network node 215 to use for transmission of a next random access message 230 transmission by the network node 215, or a network ID (e.g., a temporary cell radio network temporary ID (TC-RNTI)) for further communication with the network node 215.

Once the network node 215 successfully receives the msg2, the network node 215 may obtain uplink synchronization with the network node 205. The network node 215 may transmit the msg3 to the network node 205 using PUSCH resources assigned in the msg2. The msg3 may include scheduling information, such as a scheduling request, an RRC connection request, a buffer status, other scheduling information, or any combination thereof.

The network node 205 may receive the msg3 and may respond by transmitting the msg4, which may be a contention resolution message. The network node 205 may transmit the msg4 via a PDCCH, a PDSCH, or both. If multiple network nodes or other devices perform simultaneous random access attempts using a same preamble sequence, these network nodes may listen for a response message (e.g., the msg4) from the network node 205. Each of the network nodes may receive the msg4 and compare an ID (e.g., a network ID) in the msg4 to an ID specified in the msg3. When the IDs match, the corresponding network node (e.g., the network node 215 in the example of FIG. 2) may declare the random access procedure successful. As a result of the random access procedure, the network node 205 and the network node 215 may establish a connection (e.g., via the communication links 250-a, 250-b, or both).

Alternatively, in a two-step random access procedure, the random access messages 230 may include a msgA and a msgB. The msgA may include information corresponding to the msg1 and the msg3 of the 4-step random access procedure. For example, the msgA may include a RACH preamble and an uplink payload (e.g., uplink data). In some aspects, the msgA payload may have a configurable payload size (e.g., a few bytes up to a few hundred bytes). Additionally or alternatively, the msgA may include a MAC-CE, an uplink control information (UCI) piggyback message (e.g., a UCI message transmitted with uplink data on a physical uplink shared channel (PUSCH)), or a combination thereof. In some cases, the network node 215 may transmit the msgA on a physical uplink control channel (PUCCH), a PUSCH, or both.

The msgB may include information corresponding to the msg2 and the msg4 of the four-step random access procedure. For example, the msgB may include a contention resolution message and a downlink payload (e.g., downlink data). The msgB may be used for contention resolution and completion of the random access procedure if transmission of the msgA is successful. The network node 205 may transmit the msgB on a PDSCH, a PDCCH, or both. In some aspects, the network node 205 may transmit a first portion of the msgB on a PDCCH and a second portion of the msgB on a PDSCH. The first portion transmitted on the PDCCH may indicate PDSCH resources on which the network node 205 is scheduled to transmit the second portion of the msgB.

The network node 215 may select a random access preamble and a corresponding random access resource for transmitting the msg1 or the msgA to imitate the random access procedure based on a type of the random access procedure and one or more other random access parameters. For CFRA procedures (e.g., for beam failure recovery, system information requests, reconfigurations, a PDCCH order), the network node 215 may receive signaling or other control information that indicates a random access preamble and corresponding random access resource for the network node 215 to use. For CBRA procedures, the network node 215 may determine a random access preamble and corresponding resource to use for transmission of msg1 based on one or more reference signals (e.g., channel state information reference signals (CSI-RSs)), SSBs 220, or both.

The network node 205 may transmit one or more SSBs 220 to the network node 215 via the downlink communication link 250-b. The network node 215 may measure the SSBs 220 and select one or more of the SSBs 220 based on the measurements. In one aspect, the network node 215 may select one or more SSBs 220 having a measured signal strength, such as an RSRP, that is greater than a threshold signal strength level for PRACH transmission (e.g., a threshold value indicated via control signaling, such as rsrp-TresholdSSB). If none of the SSBs 220 have a measured signal strength that is greater than the threshold, the network node 215 may select an SSB 220 randomly, or based on one or more other metrics. Each SSB 220 may be associated with a respective set of one or more random access preambles (e.g., a random access preambles group). After selecting the one or more SSBs 220, the network node 215 may select a random access preamble randomly and with equal probability from the set of one or more random access preambles associated with the selected SSB(s) 220. The network node 215 may transmit the msg1 or the msgA using, or including, the selected random access preamble.

The network node 215 may transmit the MsgA or Msg1 during one or more random access occasions 225 based on the selected SSB(s) 220. A random access occasion 225 may be referred to as a RACH occasion (RO) and may correspond to a set of time and frequency RACH resources that are allocated for transmission of a random access preamble via, for example, a msg1, a msgA, or some other random access message 230. One or more random access occasions 225 may be associated with (e.g., linked to or mapped to) an SSB 220 (e.g., an SSB index), as illustrated by the curved arrows in FIG. 2.

A higher layer parameter (e.g., prach-ConfigurationIndex) may indicate a PRACH configuration period (e.g., 10 ms, 20 ms, 40 ms, or some other time period) for the network node 215. Each PRACH configuration period may include one or more random access slots, which may each include one or more random access occasions 225. In the example of FIG. 2, a single random access slot may be illustrated as including four random access occasions 225-a, 225-b, 225-c, and 225-d (e.g., RO #0, RO #1, RO #2, and RO #3, respectively). However, it is to be understood that a random access slot may include any quantity of random access occasions 225. The random access slots and corresponding random access occasions 225 may periodically repeat according to the PRACH configuration period.

In some random access procedures (e.g., Type-1 random access or Type-2 random access with separate configuration of PRACH occasions from Type-1), a network node may be provided with a first number (N) of SSB indices (e.g., synchronization signal (SS)/physical broadcast channel (PBCH) block indices) that are associated with a single random access occasion 225. The network node may be provided with a second number (R) of contention-based preambles per SSB index per valid random access occasion 225. The first number, the second number, or both may be provided via a parameter in an information element (IE) (e.g., via an IE in a system information block (SIB) or other control signal by a parameter such as ssb-perRACH-OccasionAndCB-PreamblesPerSSB, or some other parameter).

The first number, N, may be indicative of a quantity of SSBs 220 that may be mapped to a random access occasion 225. In one aspect, if N is less than one, a single SSB index may be mapped to 1/N consecutive valid random access occasions 225, and R contention based preambles with consecutive indices associated with the SSB index per random access occasion 225 may begin from a preamble index of zero. If N is greater than or equal to one, N SSB indices may be mapped to a single random access occasion 225, and R contention based preambles with consecutive indices associated with an SSB index of n (e.g., 0≤n≤N−1) per random access occasion 225 may begin from a preamble index of n(N_{preamble}^{total}). The parameter, N_{preamble}^{total} may be provided by an IE (e.g., totalNumberOfRA-Preambles) for a Type-1 random access procedure.

In some aspects, SSB indices may be mapped to valid random access occasions 225 in an order. For example, the SSB indices may first be mapped in increasing order of preamble indices within a single random access occasion 225. Second, the SSB indices may be mapped in increasing order of frequency resource indices for frequency multiplexed random access occasions 225. Third, the SSB indices may be mapped in increasing order of time resource indices for time multiplexed random access occasions 225 within a random access slot. Fourth, the SSB indices may be mapped in increasing order of indices for random access slots. In other aspects, the SSB indices may be mapped to random access occasions in any order, including the orders described or any other order of mapping. The SSB indices may be provided to a network node via a system information or RRC message (e.g., via ssb-PositionsInBurst in SIB1, via ServingCellConfigCommon in an RRC configuration message, or via any other IE or parameter).

An association period 235 may be defined (e.g., starting from a frame 0) for mapping SSBs 220 to random access occasions 225. The association period 235 may be defined based on a table that maps PRACH configuration periods to a set of one or more association period durations. The association period durations may correspond to different quantities of PRACH configuration periods within an association period 235. The association period 235 may be defined as the smallest value in the set of one or more association period durations associated with the PRACH configuration period such that a quantity (N_{Tx}^{SSB}) of SSBs 220 are mapped at least once to a random access occasion 225 within the association period 235. A network node may receive a control message 240 or other control signaling that indicates the value of N_{Tx}^{SSB} (e.g., RRC signaling, a SIB, or both).

If an integer number of SSBs 220 are mapped to random access occasions 225 (e.g., within an integer number of mapping cycles) within the association period 235 and there is a remaining set of random access occasions 225 or random access preambles that are not mapped to N_{Tx}^{SSB} SSBs 220, no SSBs 220 may be mapped to the remaining set of random access occasions 225 or random access preambles. An association pattern period (not pictured in FIG. 2) may be determined or defined to include one or more association periods 235 such that a pattern between random access occasions 225 and SSBs 220 repeats periodically (e.g., at most every 160 ms, or some other period). In some aspects, an association period 235 may be referred to as a random access occasion window, and each association period 235 in the periodic pattern may be referred to as a respective instance of the random access occasion window. If any random access occasions 225 remain after each SSB 220 is mapped to a random access occasion 225 in an integer quantity of association periods 235, the remaining random access occasions 225 may not be used for transmitting the random access messages 230 (e.g., for PRACH transmissions).

In some aspects, the network node 215 may support random access repetition. That is, the network node 215 may transmit multiple instances of a random access message 230 (e.g., a PRACH or PUCCH transmission having any format) using a same beam 245 or different beams 245. For example, the network node 215 may transmit multiple instances of a msg1 or a msgA to improve throughput and communication reliability. Each instance of a random access message 230 may be referred to as a repetition herein. For example, if the network node 215 transmits three instances of a random access message 230, each of the first, second, and third instances may be referred to as a repetition. Each instance or repetition of the random access message 230 may include a same format, same information, or both, such that each instance may be a copy or duplicate of each other (e.g., a retransmission). By transmitting multiple instances of a random access message 230, the network node 215 may improve throughput and communication reliability.

The network node 215 may receive a control message 240 from the network node 205 that indicates a repetition configuration, such as a quantity of instances of a random access message 230 to be transmitted by the network node 215. The control message 240 may be a SIB (e.g., SIB1), an RRC configuration, or some other control signaling. In some aspects, the network node 215 may transmit multiple PRACH transmissions using a same spatial filter that corresponds to a same beam 245 or set of beams 245. For example, the network node 215 may measure the SSBs 220 from the network node 205 and select a single SSB 220 (or other reference signal, such as a CSI-RS) that is associated with a strongest RSRP measurement. The network node 215 may transmit each instance of the random access message 230 using a spatial filter that corresponds to the selected SSB 220. The spatial filter may be the same as a spatial filter used to transmit and/or receive the selected SSB 220.

In some aspects, the network node 215 may identify multiple different SSBs 220 having a measured signal strength that is greater than the threshold. The multiple different SSBs 220 may be associated with different spatial filters. In such cases, the network node 215 may transmit multiple PRACH transmissions using different spatial filters associated with the different selected SSBs 220. However, some network nodes may not support transmissions in different directions at a same time. That is, a network node may not be capable of, or may not be permitted to, transmit two or more transmissions that partially or fully overlap in time using different spatial filters and corresponding beams 245. In some aspects, concurrent or overlapping transmissions in different directions may be associated with relatively large processing or complexity at the network node (e.g., in relatively high frequency bands, such as millimeter wave bands or above).

In the example of FIG. 2, the SSB 220-a may be associated with a first spatial filter and may be mapped to a first random access occasion 225-a (e.g., RO #0). The SSB 220-b may be associated with a second spatial filter and may be mapped to a second random access occasion 225-b (e.g., RO #1) that overlaps with the first random access occasion 225-a in time. Similarly, other SSBs 220 (not pictured in FIG. 2) may map to random access occasions 225-c and 225-d, respectively, which may overlap in time. The other SSBs 220 may be associated with third and fourth spatial filters. If the network node 215 determines that measured signal strengths of the SSB 220-a and one of the other SSBs are greater than a threshold level, the network node 215 may transmit a first instance of the random access message 230 using the first spatial filter and within the first random access occasion 225-a based on the first SSB 220-a, and the network node 215 may transmit a second instance of the random access message 230 using the third or fourth spatial filter and within the third or fourth random access occasion 225-c or 225-d based on the selected one of the SSBs 220.

However, if the network node 215 determines that measured signal strengths associated with the SSB 220-a and the SSB 220-b are both greater than a threshold level, and the measured signal strengths of other SSBs 220 do not exceed the threshold, the network node 215 may not transmit multiple corresponding PRACH transmissions in the random access occasions 225-a and 225-b because the random access occasions 225-a and 225-b overlap in time. That is, the network node 215 may not be able to transmit a first instance of a random access message 230 using the first spatial filter and within the first random access occasion 225-a and a second instance of the random access message 230 using the second spatial filter and within the second random access occasion 225-b at the same time or in partially overlapping time periods. In some aspects, the described scenario may result in ambiguity at the network node 215 regarding which spatial filter to select. Additionally or alternatively, the network node 215 may not transmit each scheduled instance of the random access message 230, which may reduce throughput and increase latency.

Techniques described herein provide for the network node 215 to multiplex multiple instances of a random access message 230 in time using different spatial filters and corresponding beams 245. The network node 215 may be configured with, or receive an indication of, a set of one or more rules that pertain to random access multiplexing when random access occasions associated with different spatial filters to be used for random access message transmissions overlap in time, frequency, or both. The network node 215 may be scheduled to transmit a quantity of instances of a random access message 230 using one or more spatial filters. A respective quantity of instances (e.g., repetitions) of the random access message 230 that are associated with each spatial filter may be determined by the network node 215 (e.g., based on a pre-defined rule or standard) or may be indicated to the network node 215 via a control message 240. The control message 240 may be a SIB (e.g., SIB1), an RRC message, or some other message or control signaling, such as a PDCCH order.

In some aspects, the control message 240 may indicate a respective quantity of instances associated with each spatial filter separately. The quantity of instances may the same or different for different spatial filters. Additionally or alternatively, the respective quantity of instances may be the same for each spatial filter and may be a defined default value. In some other aspects, the control message 240 may indicate a total quantity of instances across all spatial filters supported by the network node 215, and the network node 215 may determine how many instances of the random access message 230 to transmit using each spatial filter based on the total quantity.

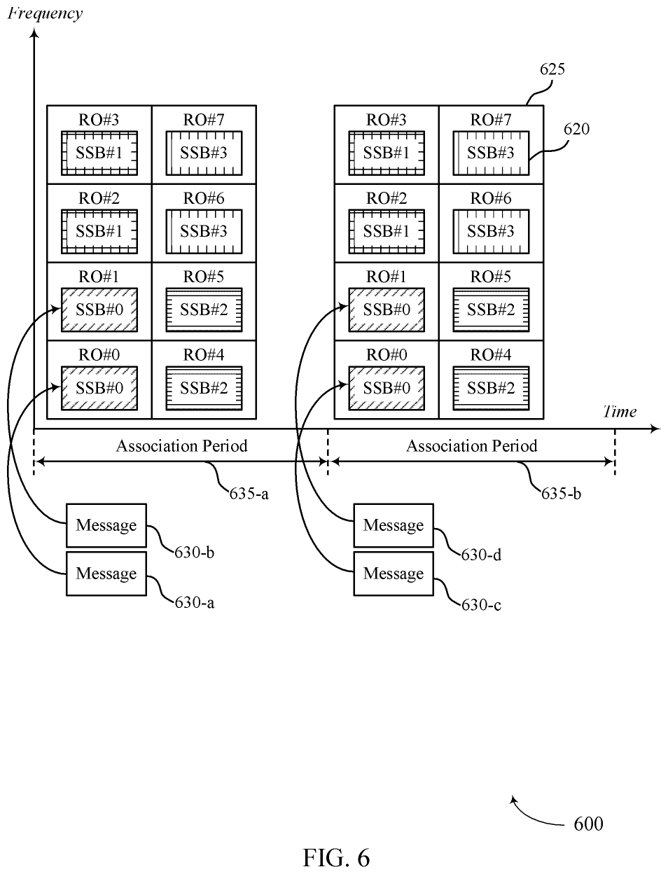

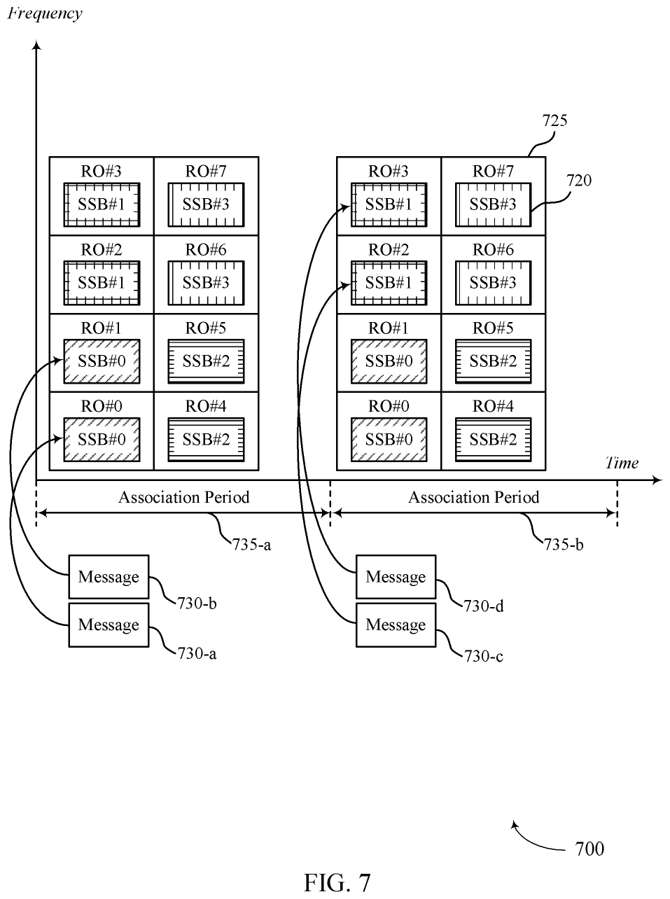

The network node 215 may multiplex transmission of the instances of the random access message 230 in time based on the determined quantity of instances that are scheduled per spatial filter and based on the set of one or more rules, which may be referred to as a rule set. The rule set may, in some aspects, be for the network node 215 to transmit each scheduled instance of the random access message 230 using a same spatial filter, as described in further detail elsewhere herein, including with reference to FIG. 6. Additionally or alternatively, the rule set may be for the network node 215 to transmit the scheduled instances of the random access message 230 using different spatial filters randomly or based on a TDM pattern specified by the rule set, as described in further detail elsewhere herein, including with reference to FIGS. 7 through 13. The rule set, the TDM pattern, or both may be defined at the network node 215 (e.g., pre-defined in a standard or configured in a memory of the network node 215) or indicated to the network node 215 via the control message 240, which may be the same as or different from the control message 240 that indicates the quantity of instances (e.g., a SIB1, an RRC message, or some other signaling).

The network node 215 may thereby support random access repetition using different spatial filters by multiplexing multiple instances of a random access message using one or more different spatial filters over time in accordance with a rule set. The random access multiplexing techniques described herein may provide for improved throughput and reliability, as well as reduced latency associated with random access procedures.

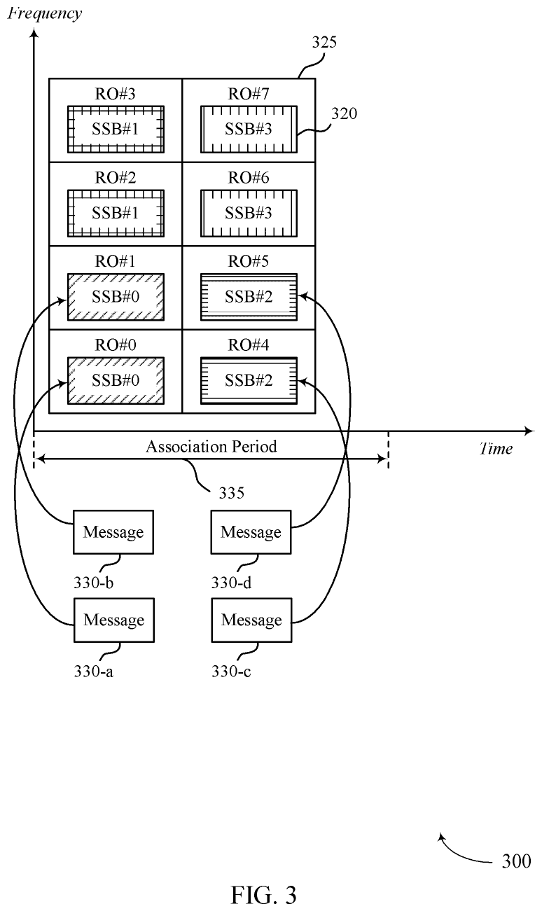

FIG. 3 illustrates an example of a random access occasion configuration 300 that supports multiplexing random access transmissions with different spatial filters in accordance with one or more aspects of the present disclosure. The random access occasion configuration 300 may implement or be implemented by aspects of the wireless communications systems 100 or 200, as described with reference to FIGS. 1 and 2. For example, the random access occasion configuration 300 illustrates a configuration of eight random access occasions 325 (e.g., ROs #0 through #7) that are mapped to four SSBs 320 (e.g., SSBs #0 through #3) within an association period 335. The random access occasions 325, the SSBs 320, and the association period 335 may represent examples of the corresponding components or elements as described with reference to FIG. 2. For example, the random access occasions 325 may each include one or more time and frequency resources within a PRACH or other channel that are allocated for transmission of a random access message (e.g., a msg1, msgA, or other PRACH transmission) by a network node, such as a UE, a base station, or some other network entity or device.

The network node may receive configuration information that indicates a quantity (N) of SSBs 320 associated with one random access occasion 325, a quantity N_{Tx}^{SSB}) of SSBs 320 which may be mapped to random access occasions 325 within a single association period 335, or both, as described with reference to FIG. 2. Additionally or alternatively, the configuration information may indicate a quantity (msg1-FDM) of random access occasions 325 that may be configured in the frequency domain. In the example of FIG. 3, N may be one half, msg1-FDM may be four, and N_{Tx}^{SSB} may be four. That is, a single SSB 320 may be associated with two random access occasions 325, four random access occasions 325 may occur within a same set of time domain resources and at different frequencies, and four SSBs 320 may be mapped to random access occasions 325 within the association period 335. Additionally or alternatively, in the example of FIG. 3, the network node may be configured or scheduled to transmit two instances of a random access message per spatial filter. Although eight random access occasions 325 and four SSBs 320 are illustrated in FIG. 3, it is to be understood that the described techniques may be applied to any quantity of random access occasions 325, any quantity of SSBs 320, and any quantity of corresponding spatial filters.

The network node may receive the SSBs 320 and measure a signal strength associated with each SSB 320. In some aspects, the network node may detect that a measured signal strength (e.g., RSRP) of the SSB #0 and a measured signal strength of the SSB #2 both exceed a threshold value. The network node may thereby select the SSB #0 and the SSB #2 for transmission of one or more instances 330 of a random access message (e.g., msg1 or msgA). The SSB #0 may be associated with a first spatial filter (e.g., beam) and may map to the random access occasion #0 and the random access occasion #1. The SSB #2 may be associated with a second spatial filter (e.g., beam) and may map to the random access occasion #4 and the random access occasion #5.

The network node may transmit two instances 330 of the random access message, such as the instances 330-a and 330-b in the random access occasion #0 and the random access occasion #1, respectively, using the first spatial filter associated with the SSB #0. The network node may subsequently transmit two instances 330 of the random access message, such as the instances 330-c and 330-d in the random access occasion #4 and the random access occasion #5, respectively, using the second spatial filter associated with the SSB #2. Thus, the network node may transmit four PRACH repetitions using two spatial filters and two repetitions per spatial filter. In such cases, the network node may refrain from transmitting two or more instances 330 of the random access message using different spatial filters at a same time.

In some other aspects, the network node may detect two or more SSBs 320 that exceed the threshold signal strength value, that are associated with different spatial filters, and that map to random access occasions 325 that overlap in time. For example, the network node may detect that the SSB #0 and the SSB #1 exceed the RSRP threshold (e.g., and the SSBs #2 and #3 may not exceed the RSRP threshold). The SSB #1 may be associated with a second spatial filter that is different than a first spatial filter associated with the SSB #0, and the SSB #1 may map to the random access occasions #2 and #3, which may overlap in time with the random access occasions #0 and #1.

In such cases, the network node may not support simultaneous or overlapping transmission of instances 330 of the random access message in the random access occasions #0 through #3 using different spatial filters. Rather, the network node may transmit two instances 330 of the random access message using one spatial filter at a time. For example, the network node may transmit the instances 330-a and 330-b using the first spatial filter during the random access occasions #0 and #1. The network node may refrain from transmitting the other two scheduled instances of the random access message due to the random access occasions #2 and #3 overlapping in time with the random access occasions #0 and #1.

Techniques described herein provide for the network node to multiplex transmissions of instances 330 of a random access message using different spatial filters over time based on one or more rules for random access multiplexing. For example, the network node may multiplex transmissions of the instances 330 at different times within the same or different association periods 335. Example multiplexing patterns are described in further detail elsewhere herein, including with reference to FIGS. 6 through 13.

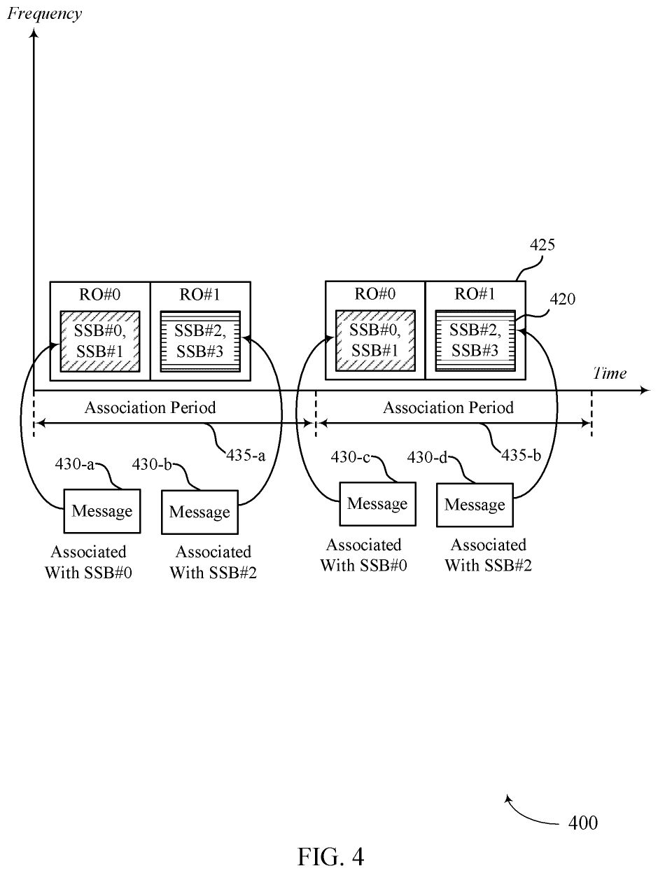

FIG. 4 illustrates an example of a random access occasion configuration 400 that supports multiplexing random access transmissions with different spatial filters in accordance with one or more aspects of the present disclosure. The random access occasion configuration 400 may implement or be implemented by aspects of the wireless communications systems 100 or 200, as described with reference to FIGS. 1 and 2. For example, the random access occasion configuration 400 illustrates a configuration of two random access occasions 425 (e.g., ROs #0 and #1) that are mapped to four SSBs 420 (e.g., SSBs #0, #1, #2, and #3) within each of the association periods 435-a and 435-b. The random access occasions 425, the SSBs 420, and the association periods 435 may represent examples of the corresponding components or elements as described with reference to FIGS. 2 and 3. For example, the random access occasions 425 may each include one or more time and frequency resources allocated for transmission of a random access message (e.g., a msg1, msgA, or some other PRACH transmission) by a network node, such as a UE or some other network entity.

The network node may receive configuration information that indicates a quantity (N) of SSBs 420 associated with one random access occasion 425, a quantity (N_{Tx}^{SSB}) of SSBs 420 which may be mapped to random access occasions 425 within a single association period 435, or both, as described with reference to FIGS. 2 and 3. Additionally or alternatively, the configuration information may indicate a quantity (msg1-FDM) of random access occasions 425 that may be allocated in the frequency domain. In the example of FIG. 4, N may be two, msg1-FDM may be one, and N_{Tx}^{SSB} may be four. That is, two SSBs 420 may be associated with a single random access occasion 425, a single random access occasion 425 may occur at a time, and four SSBs 420 may be mapped to random access occasions 425 within each association period 435. Additionally or alternatively, in the example of FIG. 4, the network node may be configured to transmit four total instances 430 of a random access message, including two instances 430 transmitted per spatial filter. Although two random access occasions 425 and four SSBs 420 are illustrated in FIG. 4, it is to be understood that the described techniques may be applied to any quantity of random access occasions 425, any quantity of SSBs 420, and any quantity of corresponding spatial filters.

The network node may receive each of the SSBs 420 and measure a signal strength associated with each SSB 420. In some aspects, the network node may detect that a measured signal strength (e.g., RSRP) of the SSB #0 and the SSB #2 exceed a threshold value. The network node may thereby select the SSB #0 and the SSB #2 for transmission of one or more instances 430 of a random access message (e.g., msg1 or msgA). The SSB #0 may be associated with a first spatial filter (e.g., beam) and may map to the random access occasion #0. The SSB #2 may be associated with a second spatial filter (e.g., beam) and may map to the random access occasion #1.

The network node may transmit two instances 430 of the random access message, such as the instances 430-a and 430-c, in the random access occasion #0 during two consecutive association periods 435-a and 435-b, respectively, using the first spatial filter associated with the SSB #0. The network node may transmit two instances 430 of the random access message, such as the instances 430-b and 430-d, in the random access occasion #1 during the two consecutive association periods 435-a and 435-b, respectively, using the second spatial filter associated with the SSB #2. Thus, the network node may transmit four PRACH repetitions using two spatial filters and two repetitions per spatial filter. In such cases, the network node may refrain from transmitting two instances 430 of the random access message using different spatial filters at a same time.

In some other aspects, the network node may detect two or more SSBs 420 that exceed the threshold signal strength value, are associated with different spatial filters, and map to random access occasions 425 that overlap in time. For example, the network node may detect that the SSB #0 and the SSB #1 exceed the RSRP threshold (e.g., and the SSBs #2 and #3 may not exceed the RSRP threshold). The SSB #1 may be associated with a second spatial filter that is different than a first spatial filter associated with the SSB #0. The SSB #1 may map to the same random access occasions #0 as the SSB #0 (e.g., overlapping time resources).

In such cases, the network node may not support simultaneous or overlapping transmission of instances 430 of the random access message in the random access occasion #0 using different spatial filters. Rather, the network node may transmit two instances 430 of the random access message using one filter at a time. For example, the network node may transmit the instances 430-a and 430-c using the first spatial filter during the random access occasion #0 in the association periods 435-a and 435-b, respectively. The network node may refrain from transmitting the other two instances 430 of the random access message due to the corresponding resources overlapping in time.

Techniques described herein provide for the network node to multiplex transmissions of a random access message using different spatial filters based on one or more rules pertaining to random access multiplexing. For example, the network node may multiplex transmissions of the instances 430 at different times within the same or different association periods 435. Example multiplexing patterns are described in further detail elsewhere herein, including with reference to FIGS. 6 through 13.

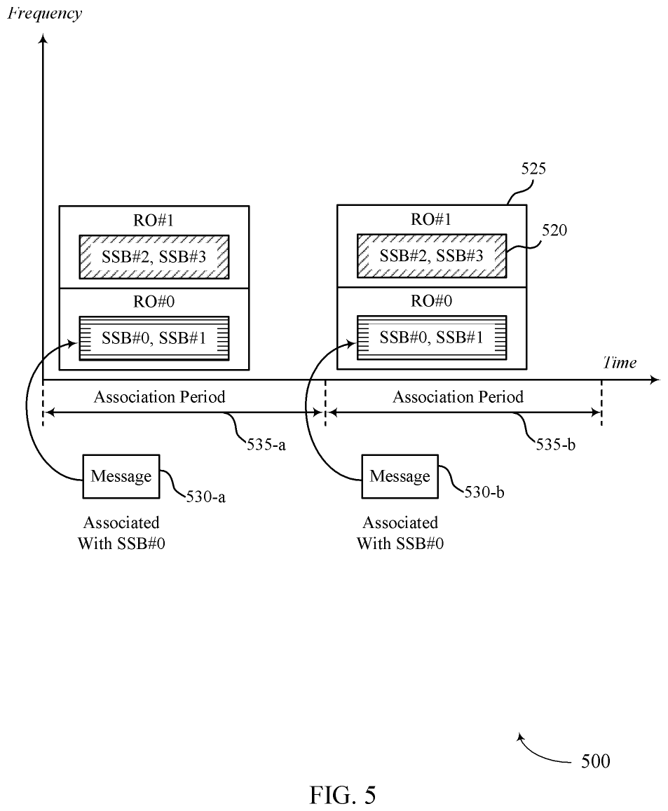

FIG. 5 illustrates an example of a random access occasion configuration 500 that supports multiplexing random access transmissions with different spatial filters in accordance with one or more aspects of the present disclosure. The random access occasion configuration 500 may implement or be implemented by aspects of the wireless communications systems 100 or 200, as described with reference to FIGS. 1 and 2. For example, the random access occasion configuration 500 illustrates a configuration of two random access occasions 525 (e.g., ROs #0 and #1) that are mapped to four SSBs 520 (e.g., SSBs #0, #1, #2, and #3) within each of the association periods 535-a and 535-b.

The random access occasions 525, the SSBs 520, and the association periods 535 may represent examples of the corresponding components or elements as described with reference to FIGS. 2 through 4. For example, the random access occasions 525 may each include one or more time and frequency resources allocated for transmission of a random access message (e.g., a msg1, msgA, or some other PRACH transmission) by a network node. The association periods 535 including the one or more random access occasions 525 may repeat periodically over time, and may be referred to as random access occasion windows, as described with reference to FIG. 2. In some aspects, the association period 535-a may represent a first instance of a random access occasion window and the association period 535-b may represent a second or additional instance of the random access occasion window.

The network node may receive configuration information that indicates a quantity (N) of SSBs 520 associated with one random access occasion 525, a quantity (N_{Tx}^{SSB}) of SSBs 520 which may be mapped to random access occasions 525 within a single association period 535, or both, as described with reference to FIGS. 2 through 4. Additionally or alternatively, the configuration information may indicate a quantity (msg1-FDM) of random access occasions 525 that may be configured in the frequency domain. In the example of FIG. 5, N may be two, msg1-FDM may be two, and N_{Tx}^{SSB} may be four. That is, two SSBs 520 may be associated with a single random access occasion 525, two random access occasions 525 may occur at a time, and four SSBs 520 may be mapped to random access occasions 525 within each association period 535. Additionally or alternatively, in the example of FIG. 5, the network node may be configured to transmit four total instances 530 of a random access message, including two instances per spatial filter. Although two random access occasions 525 and four SSBs 520 are illustrated in FIG. 5, it is to be understood that the described techniques may be applied to any quantity of random access occasions 525, any quantity of SSBs 520, and any quantity of corresponding spatial filters.

The network node may receive each of the SSBs 520 and measure a signal strength associated with each SSB 520. In the example of FIG. 5, each of the SSBs #0 through #3 may be associated with a different spatial filter, and any combination of two or more of the SSBs #0 through #3 may map to random access resources that overlap in time. In this example, the network node may not support simultaneous or overlapping transmission of instances 530 of the random access message using different spatial filters. Rather, the network node may transmit each instance 530 of the random access message using one filter at a time.

In the example illustrated in FIG. 5, the network node may determine that any combination of SSBs 520 including at least the SSB #0 exceed the threshold signal strength value. The network node may transmit the instances 530-a and 530-b of the random access message using a first spatial filter associated with the SSB #0 during the random access occasion #0 in the association periods 535-a and 535-b, respectively. The network node may refrain from transmitting other instances 530 of the random access message due to the other random access occasions 525 overlapping in time and being associated with different spatial filters.

Techniques described herein provide for the network node to multiplex transmissions of a random access message using different spatial filters based on one or more rules pertaining to random access multiplexing. For example, the network node may multiplex transmissions of the instances 530 at different times within the same or different association periods 535 based on the one or more rules. Example multiplexing patterns are described in further detail elsewhere herein, including with reference to FIGS. 6 through 13.

FIG. 6 illustrates an example of a random access message repetition diagram 600 that supports multiplexing random access transmissions with different spatial filters in accordance with one or more aspects of the present disclosure. The random access message repetition diagram 600 may implement or be implemented by aspects of the wireless communications systems 100 or 200, as described with reference to FIGS. 1 and 2. For example, the random access message repetition diagram 600 illustrates an example pattern for transmitting multiple instances 630 of a random access message (e.g., PRACH repetitions) by a network node. The random access message repetition diagram 600 illustrates eight random access occasions 625 (e.g., ROs #0 through #7) that are mapped to four SSBs 620 (e.g., SSBs #0 through #3) within each of the association periods 635-a and 635-b. The random access occasions 625, the SSBs 620, and the association periods 635 may represent examples of corresponding components or elements as described with reference to FIGS. 2 through 5.

The mapping between SSBs 620 and random access occasions 625 in the random access message repetition diagram 600 may be the same as or similar to the mapping illustrated in the random access occasion configuration 300 described with reference to FIG. 3. For example, a single SSB 620 may be mapped to two random access occasions 625, four random access occasions 625 may occur at a time, and four SSBs 620 may be mapped to random access occasions 625 within each association period 635. Additionally or alternatively, in the example of FIG. 6, the network node may be configured to transmit four total instances 630 of a random access message, including two instances or transmissions per spatial filter.

As described with reference to FIG. 3, if the network node determines that a first measured signal strength of the SSB #0 and a second measured signal strength of the SSB #1 both exceed a threshold value, the network node may be unable to transmit four instances 630 of the random access message in the association period 635-a. Similarly, the network node may be unable to transmit four instances 630 of the random access message in the association period 635-a using the SSB #2 and the SSB #3 due to the SSBs 620 being associated with different spatial filters and overlapping time resources. To improve random access repetition, a rule set as described herein may be indicated to the network node or configured for the network node for random access message multiplexing when random access occasions 625 associated with different spatial filters to be used for transmission of random access messages overlap in time, as described in further detail with reference to FIG. 2. By transmitting instances or repetitions of the random access message in accordance with the rule, the network node may improve throughput and reliability of a random access procedure.

In the example of FIG. 6, the rule set may be that the network node transmits each instance 630 of a random access message using a same spatial filter. That is, if the network node is configured to transmit multiple instances 630 of the random access message using different spatial filters and via overlapping time resources, the network node may select resources associated with a single spatial filter to transmit all of the configured or scheduled instances 630. The network node may thereby fallback to transmitting multiple instances using a same spatial filter.

The network node may select which spatial filter to use from a set of two or more spatial filters that correspond to SSBs 620 that have a measured signal strength that exceeds a threshold value. The network node may select the suitable spatial filter based on a measurement of each SSB 620, based on the rule set, based on a default configuration, or any combination thereof. In some aspects, the network node may select the spatial filter associated with the SSB 620 having the greatest measured signal strength. Additionally or alternatively, the rule set may be for the network node to select a spatial filter associated with a certain SSB 620 (e.g., an SSB 620 having a highest or lowest index value), or some other rule for selecting a spatial filter.

In the example of FIG. 6, the network node may be configured to transmit four instances 630 of the random access message. The network node may determine that the SSB #0 and the SSB #1 exceed the threshold signal strength value, but the SSB #2 and the SSB #3 do not exceed the threshold. Each of the SSBs 620 may be associated with different spatial filters. The network node may be configured with a rule set for selecting a single spatial filter to use for transmitting the four instances when random access occasions 625 associated with different spatial filters overlap in time. The network node may select the first spatial filter associated with the SSB #0. The network node may transmit two instances 630-a and 630-b using the first spatial filter within the random access occasion #1 during the first association period 635-a and the network node may transmit the remaining two instances 630-c and 630-d using the first spatial filter within the random access occasion #1 during the second association period 635-b.

Thus, in some aspects described herein, a network node may select a single spatial filter for transmitting each repetition of a random access message to improve throughput and communication reliability. Although eight random access occasions 625 and four SSBs 620 are illustrated in FIG. 6, it is to be understood that the described techniques may be applied to any quantity of random access occasions 625 and any quantity of SSBs 620. For example, a network node may select a single spatial filter for transmitting any quantity of instances of a random access message during any quantity of association periods 635 and via any configuration of random access occasions 625.

FIG. 7 illustrates an example of a random access message repetition diagram 700 that supports multiplexing random access transmissions with different spatial filters in accordance with one or more aspects of the present disclosure. The random access message repetition diagram 700 may implement or be implemented by aspects of the wireless communications systems 100 or 200, as described with reference to FIGS. 1 and 2. For example, the random access message repetition diagram 700 illustrates an example pattern for transmitting multiple instances 730 of a random access message (e.g., PRACH repetitions) by a network node. The random access message repetition diagram 700 illustrates eight random access occasions 725 (e.g., ROs #0 through #7) that are mapped to four SSBs 720 (e.g., SSBs #0 through #3) within each of the association periods 735-a and 735-b. The random access occasions 725, the SSBs 720, and the association periods 735 may represent examples of corresponding components or elements as described with reference to FIGS. 2 through 6.

The mapping between SSBs 720 and random access occasions 725 in the random access message repetition diagram 700 may be the same as or similar to the mapping illustrated in the random access occasion configuration 300 described with reference to FIG. 3 and the random access message repetition diagram 600 described with reference to FIG. 6. For example, a single SSB 720 may be mapped to two random access occasions 725, four random access occasions 725 may occur at a time, and four SSBs 720 may be mapped to random access occasions 725 within each association period 735. Additionally or alternatively, in the example of FIG. 7, the network node may be configured to transmit four total instances 730 of a random access message, including two instances 730 per spatial filter.

As described with reference to FIGS. 3 and 6, if the network node determines that a first measured signal strength of the SSB #0 and a second measured signal strength of the SSB #1 both exceed a threshold value, the network node may be unable to transmit four instances 730 of the random access message in the association period 735-a. Similarly, the network node may be unable to transmit four instances 730 of the random access message in the association period 735-a based on the SSB #2 and the SSB #3 because the SSBs #2 and #3 are associated with different spatial filters and overlapping time resources. To improve random access repetitions, a rule set may be indicated to the network node or configured for the network node for random access message multiplexing when random access occasions 725 associated with different spatial filters to be used for transmission of random access messages overlap in time, as described with reference to FIG. 2. By transmitting instances or repetitions of the random access message in accordance with the rule set, the network node may improve throughput and reliability of a random access procedure.

In the example of FIG. 7, the rule set may be that the network node transmits instances 730 of a random access message using different spatial filters. That is, if the network node is configured to transmit multiple instances 730 of the random access message using different spatial filters and within overlapping time resources, the network node may select resources associated with a first spatial filter to transmit a first subset of the configured or scheduled instances 730 and resources associated with a second spatial filter to transmit a second subset of the configured or scheduled instances 730. Each subset of instances 730 may include up to the configured quantity of instances 730 per spatial filter. The network node may TDM the multiple instances using the different spatial filters according to a pattern. The multiplexing pattern may be configured (e.g., pre-configured or pre-defined in a standard) or indicated to the network node via a control message. In some aspects, the multiplexing pattern may be indicated to the network node via system information (e.g., SIB1) or an RRC configuration. In some aspects, the network node may receive a control message that indicates the rule set, as described with reference to FIG. 2, and the rule set may include or specify the multiplexing pattern.

In the example of FIG. 7, the network node may be configured to transmit four instances 730 of the random access message. The network node may determine that the SSB #0 and the SSB #1 exceed the threshold signal strength value, but the SSB #2 and the SSB #3 do not exceed the threshold. Each of the SSBs 720 may be associated with different spatial filters. The network node may select the first spatial filter associated with the SSB #0 for transmission of the first two instances 730-a and 730-b within the random access occasions #0 and #1, respectively, during the first association period 735-a. The network node may select the second spatial filter associated with the SSB #1 for transmission of the second two instances 730-c and 730-d within the random access occasions #2 and #3, respectively, during the second association period 735-b.

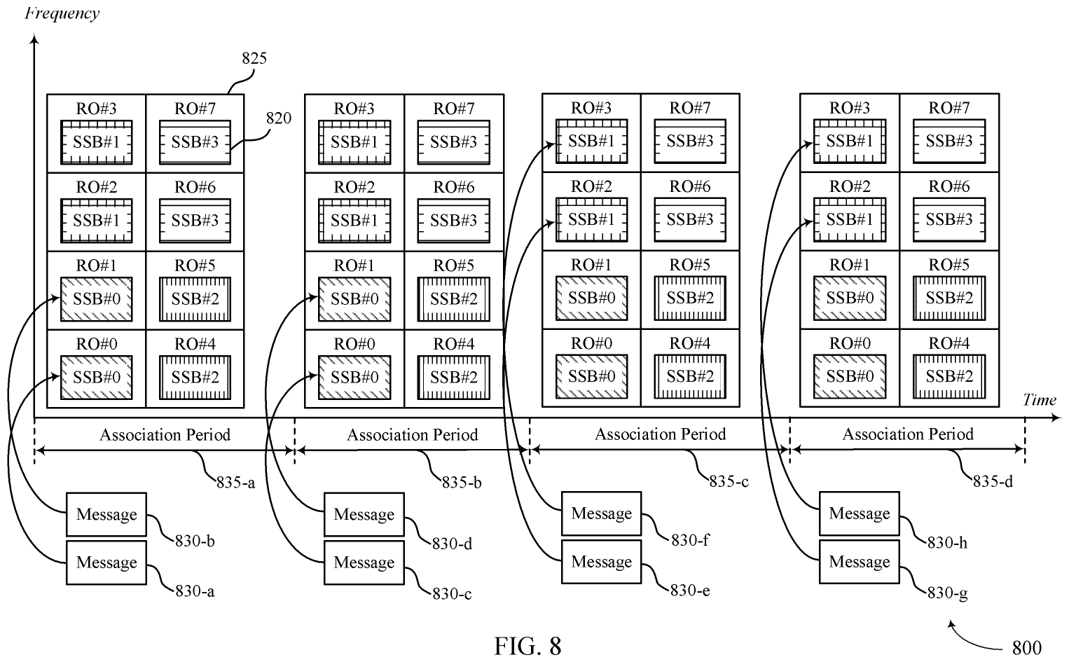

Thus, in some aspects described herein, a network node may multiplex instances 730 of a random access message using any quantity of two or more different spatial filters over time to improve throughput and communication reliability. The network node may multiplex the instances 730 according to a multiplexing pattern, such as a TDM multiplexing pattern. Example multiplexing patterns are described in further detail elsewhere herein, including with reference to FIGS. 8 through 13.

FIGS. 8 through 13 illustrate examples of random access multiplexing patterns. As described with reference to FIG. 2, a network node may determine a quantity of instances or repetitions of a random access message to transmit per spatial filter. In the example of FIGS. 8 through 13, the network node may identify a first quantity of instances associated with a first spatial filter and a second quantity of instances associated with a second spatial filter. The network node may transmit instances of the random access message until a sum of all of the transmitted instances equals a combination of the first quantity and the second quantity.

In some aspects, the network node may receive a message that indicates the first quantity separately from the second quantity. Additionally or alternatively, the message may indicate a total quantity of instances, and the network node may determine the first and second quantities based on the total quantity of instances and one or more parameters or measurements obtained by the network node. The first quantity of instances associated with the first spatial filter may be the same as or different from the second quantity of instances associated with the second spatial filter.

The network node may follow a rule set for random access message multiplexing when random access occasions associated with different spatial filters to be used for random access message transmissions overlap in time, as described with reference to FIGS. 1 through 7. In some aspects, the rule set may indicate or specify a TDM multiplexing pattern, and the network node may multiplex transmission of the first quantity of instances and the second quantity of instances over time in accordance with the random access multiplexing pattern. The multiplexing pattern may be, for example, one of a first multiplexing pattern or a second multiplexing pattern for transmitting the first and second quantities of instances.

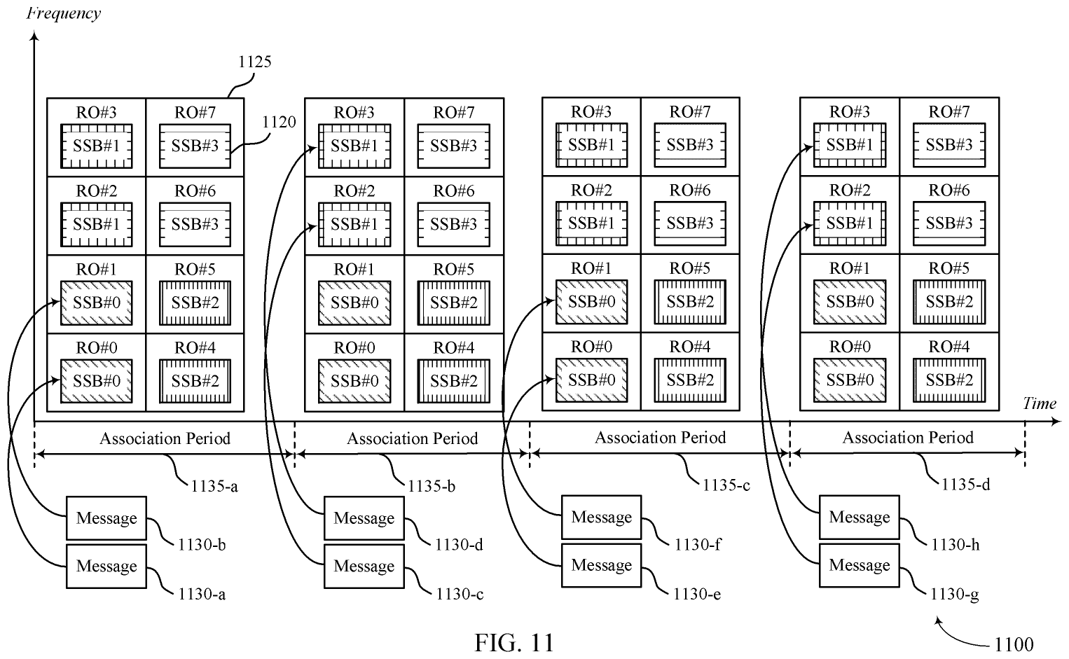

The first multiplexing pattern may correspond to a pattern in which the first quantity of instances associated with the first spatial filter are transmitted first and the second quantity of instances associated with the second spatial filter are transmitted second, after the first quantity of instances are transmitted. FIGS. 8 through 10 illustrate examples of the first multiplexing pattern. The second multiplexing pattern may correspond to a pattern in which the first quantity of instances associated with the first spatial filter and the second quantity of instances associated with the second spatial filter are transmitted in an alternating or interleaved manner. For example, a network node may alternate between a transmission using the first spatial filter and a transmission using the second spatial filter. Additionally or alternatively, the second multiplexing pattern may specify a periodicity for interleaving the transmissions. For example, the second multiplexing pattern may specify a time period or a quantity of transmissions before alternating to using a different spatial filter, such that the network node may transmit the indicated quantity of transmissions using the first spatial filter then switch to transmitting another quantity of transmissions using the second spatial filter, and so on until the total quantity of instances are transmitted. FIGS. 11 through 13 illustrate examples of the second multiplexing pattern.

The examples illustrated in FIGS. 8 through 13 are not to be considered limiting. Although the example multiplexing patterns described with respect to FIGS. 8 through 13 illustrate example patterns for multiplexing between two spatial filters, it is to be understood that the network node may apply the described techniques using any quantity of spatial filters and any quantity of instances or repetitions. For example, a multiplexing pattern may be configured or indicated for multiplexing random access repetitions using any quantity of spatial filters and any quantity of instances of a random access message over time, including the patterns and quantities illustrated as well as patterns and quantities not shown in FIGS. 8 through 13.

FIG. 8 illustrates an example of a random access multiplexing pattern 800 that supports multiplexing random access transmissions with different spatial filters in accordance with one or more aspects of the present disclosure. The random access multiplexing pattern 800 may implement or be implemented by aspects of the wireless communications systems 100 or 200, as described with reference to FIGS. 1 and 2. For example, the random access multiplexing pattern 800 illustrates an example pattern for multiplexing multiple instances 830 of a random access message (e.g., PRACH repetitions) by a network node. The random access multiplexing pattern 800 illustrates eight random access occasions 825 (e.g., ROs #0 through #7) that are mapped to four SSBs 820 (e.g., SSBs #0 through #3) within each of the association periods 835-a, 835-b, 835-c, and 835-d. The random access occasions 825, the SSBs 820, and the association periods 835 may represent examples of corresponding components or elements as described with reference to FIGS. 2 through 7.

The mapping between SSBs 820 and random access occasions 825 in the random access multiplexing pattern 800 may be the same as or similar to the mapping illustrated in the random access occasion configuration 300 described with reference to FIG. 3 and the random access message repetition diagrams 600 and 700 described with reference to FIGS. 6 and 7. For example, a single SSB 820 may be mapped to two random access occasions 825, four random access occasions 825 may occur at a time, and four SSBs 820 may be mapped to random access occasions 825 within each association period 835 (e.g., each instance of a random access occasion window).

In the example of FIG. 8, the network node may detect that a first measured signal strength of the SSB #0 and a second measured signal strength of the SSB #1 exceed a threshold value. The network node may detect that measured signal strengths of the SSBs #2 and #3 do not exceed the threshold value. The SSB #0 may be associated with a first spatial filter and mapped to the random access occasions #0 and #1. The SSB #1 may be associated with a second spatial filter and mapped to the random access occasions #2 and #3, which may overlap in time with the random access occasions #0 and #1.

The network node may be scheduled to transmit eight instances 830 of a random access message. In some aspects, a first quantity of four instances 830 may be associated with the first spatial filter and a second quantity of four instances 830 may be associated with the second spatial filter. That is, the network node may be configured to transmit a same quantity of PRACH transmissions for each different spatial filter. FIG. 8 illustrates an example in which the network node may apply the first multiplexing pattern to multiplex all eight instances 830 of the random access message using both spatial filters in time. For example, the network node may transmit each of the first quantity of instances 830 using the first spatial filter first, before transmitting each of the second quantity of instances 830 using the second spatial filter.

The network node may use the first spatial filter to transmit the instances 830-a and 830-b via the random access occasions #0 and #1, respectively during the first association period 835-a. The network node may continue to use the first spatial filter to transmit the instances 830-c and 830-d via the random access occasions #0 and #1, respectively during the second association period 835-b. The network node may not have any more instances 830 to transmit using the first spatial filter after the association period 835-b (e.g., the four scheduled instances 830 per the first spatial filter may be transmitted). In accordance with the rule and the first multiplexing pattern, the network node may use the second spatial filter to transmit the remaining scheduled instances 830. For example, the network node may use the second spatial filter to transmit the instances 830-e and 830-f via the random access occasions #2 and #3, respectively during the third association period 835-c. The network node may subsequently use the second spatial filter to transmit the remaining instances 830-g and 830-h via the random access occasions #2 and #3, respectively, during the fourth association period 835-d. The network node may thereby transmit a total of eight instances 830 of the random access message using two spatial filters based on the first multiplexing pattern.

In some aspects, the network node may be configured to transmit different quantities of instances 830 per spatial filter. In such cases, the network node may transmit a first quantity of instances 830 using the first spatial filter and during available random access occasions 825 that are associated with the first spatial filter first. The network node may subsequently transmit the remaining quantity of instances 830 using the second spatial filter and during available random access occasions 825 that are associated with the second spatial filter. For example, if the network node determines, or receives an indication, that a first quantity of instances 830 associated with the first spatial filter includes six instances 830 and a second quantity of instances 830 associated with the second spatial filter includes two instances 830, or some other quantities of instances 830, the network node may transmit the instances 830-a through 830-f via the random access occasions #0 and #1 during each of the association periods 835-a, 835-b, and 835-c before transmitting the remaining instances 830-g and 830-h via the random access occasions #2 and #3 during the association period 835-d (not illustrated in FIG. 8).

The network node may begin transmissions according to the first multiplexing pattern using either the first spatial filter or the second spatial filter. In some aspects, the rule or the multiplexing pattern may indicate which spatial filter the pattern should begin with. For example, the multiplexing pattern may indicate that a spatial filter associated with an SSB 820 having a highest or lowest index value, or with an SSB 820 having a highest or lowest signal strength measurement should be selected. Additionally or alternatively, the network node may select the SSB 820 and corresponding spatial filter to start the multiplexing pattern randomly or based on one or more parameters. In some aspects, the network node may select the spatial filter based on a quantity of instances 830 associated with the spatial filter or based on a complexity or power consumption associated with transmissions using the spatial filter.

In some aspects (not illustrated in FIG. 8), the network node may detect that the SSB #0 and the SSB #2 exceed the threshold signal strength value, or any two or more SSBs 820 that correspond to random access occasions 825 that do not overlap in time. In such cases, the network node may still utilize the first multiplexing pattern for transmission of eight instances 830 of the random access message during the four association periods 835-a through 835-d. In such cases, for example, each of the instances 830-a through 830-d may be transmitted via one of the random access occasions #0 and #1 associated with the SSB #0 in the association periods 835-a and 835-b using the first spatial filter associated with the SSB #0. After four instances are transmitted using the first spatial filter, each of the instances 830-e through 830-h may be transmitted via one of the random access occasions #4 and #5 associated with the SSB #2 using a third spatial filter associated with the SSB #2 in accordance with the first multiplexing pattern.

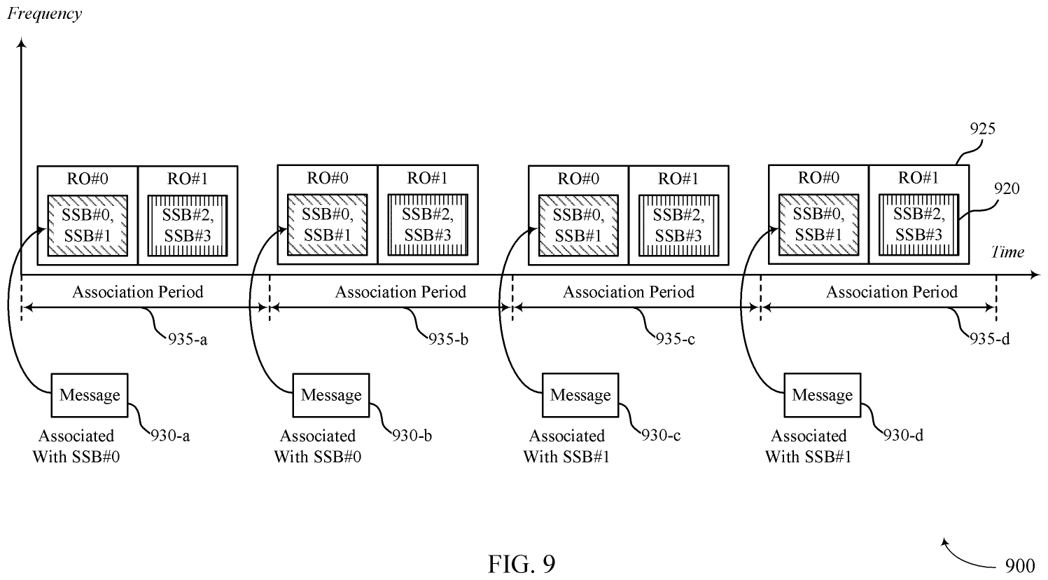

FIG. 9 illustrates an example of a random access multiplexing pattern 900 that supports multiplexing random access transmissions with different spatial filters in accordance with one or more aspects of the present disclosure. The random access multiplexing pattern 900 may implement or be implemented by aspects of the wireless communications systems 100 or 200, as described with reference to FIGS. 1 and 2. For example, the random access multiplexing pattern 900 illustrates an example pattern for multiplexing multiple instances 930 of a random access message (e.g., PRACH repetitions) by a network node. The random access multiplexing pattern 900 illustrates two random access occasions 925 (e.g., ROs #0 and #1) that are mapped to four SSBs 920 (e.g., SSBs #0 through #3) within each of the association periods 935-a, 935-b, 935-c, and 935-d. The random access occasions 925, the SSBs 920, and the association periods 935 may represent examples of corresponding components or elements as described with reference to FIGS. 2 through 8.

The mapping between SSBs 920 and random access occasions 925 in the random access multiplexing pattern 900 may be the same as or similar to the mapping illustrated in the random access occasion configuration 400 described with reference to FIG. 4. For example, two SSBs 920 may be mapped to a single random access occasion 925, one random access occasion 925 may occur at a time, and four SSBs 920 may be mapped to random access occasions 925 within each association period 935.

The network node may detect that a first measured signal strength of the SSB #0 and a second measured signal strength of the SSB #1 exceed a threshold value. The network node may detect that measured signal strengths of the SSBs #2 and #3 do not exceed the threshold value. The SSB #0 may be associated with a first spatial filter and mapped to the random access occasion #0. The SSB #1 may be associated with a second spatial filter and mapped to the random access occasion #0, such that transmissions corresponding to the SSBs #0 and #1 may overlap in time (and, in some aspects, frequency).

The network node may be scheduled to transmit four instances 930 of a random access message. In some aspects, a first quantity of two instances 930 may be associated with the first spatial filter and a second quantity of two instances 930 may be associated with the second spatial filter. That is, the network node may be configured to transmit a same quantity of PRACH transmissions for each different spatial filter. FIG. 9 illustrates an example in which the network node may apply the first multiplexing pattern to multiplex all four instances 930 of the random access message using both spatial filters in time. For example, the network node may transmit each of the first quantity of instances 930 using the first spatial filter first, before transmitting each of the second quantity of instances 930 using the second spatial filter.

The network node may start by using the first spatial filter associated with the SSB #0 to transmit the instances 930-a and 930-b via the random access occasion #0 in the first association period 935-a and the second association period 935-b, respectively. The network node may not have any more instances 930 of the random access message to transmit using the first spatial filter after the association period 935-b (e.g., the two scheduled instances 930 per the first spatial filter may be transmitted). In accordance with the rule set and the second multiplexing pattern, the network node may subsequently switch to using the second spatial filter associated with the SSB #1 to transmit the remaining instances 930-c and 930-d via the random access occasion #0 and in each of the third association period 935-c and the fourth association period 935-d. The network node may thereby transmit a total of four instances 930 of the random access message using two spatial filters based on the first multiplexing pattern.

In some aspects, the network node may be configured to transmit different quantities of instances 930 per spatial filter. In such cases, the network node may transmit a first quantity of instances 930 using the first spatial filter and during available random access occasions 925 that are associated with the first spatial filter first. The network node may subsequently transmit the remaining quantity of instances 930 using the second spatial filter and during available random access occasions 925 that are associated with the second spatial filter. For example, if the network node determines, or receives an indication, that a first quantity of instances 930 associated with the first spatial filter includes three instances 930 and a second quantity of instances 930 associated with the second spatial filter includes one instance 930 (not pictured in FIG. 9), the network node may use the first spatial filter to transmit the three instances 930-a through 930-c via the random access occasion #0 during each of the association periods 935-a, 935-b, and 935-c before using the second spatial filter to transmit the remaining instance 930-d via the random access occasion #0 during the association period 935-d.

The network node may begin transmissions according to the first multiplexing pattern using either the first spatial filter or the second spatial filter. In some aspects, the rule set or the multiplexing pattern may indicate which spatial filter the pattern should begin with, or the network node may select the SSB and corresponding spatial filter to start the multiplexing pattern randomly or based on one or more parameters, as described with reference to FIG. 8.

In some aspects (not illustrated in FIG. 9), the network node may detect that the SSB #0 and the SSB #2 exceed the threshold signal strength value, or any two or more SSBs 920 that correspond to random access occasions 925 that do not overlap in time. In such cases, the network node may still utilize the first multiplexing pattern for transmission of instances 930 of the random access message. In such cases, for example, after the instances 930-a and 930-b are transmitted using the first spatial filter, each of the instances 930-c and 930-d may be transmitted using a third spatial filter associated with the SSB #2 and via the random access occasion #1 during the association periods 935-c and 935-d, respectively.

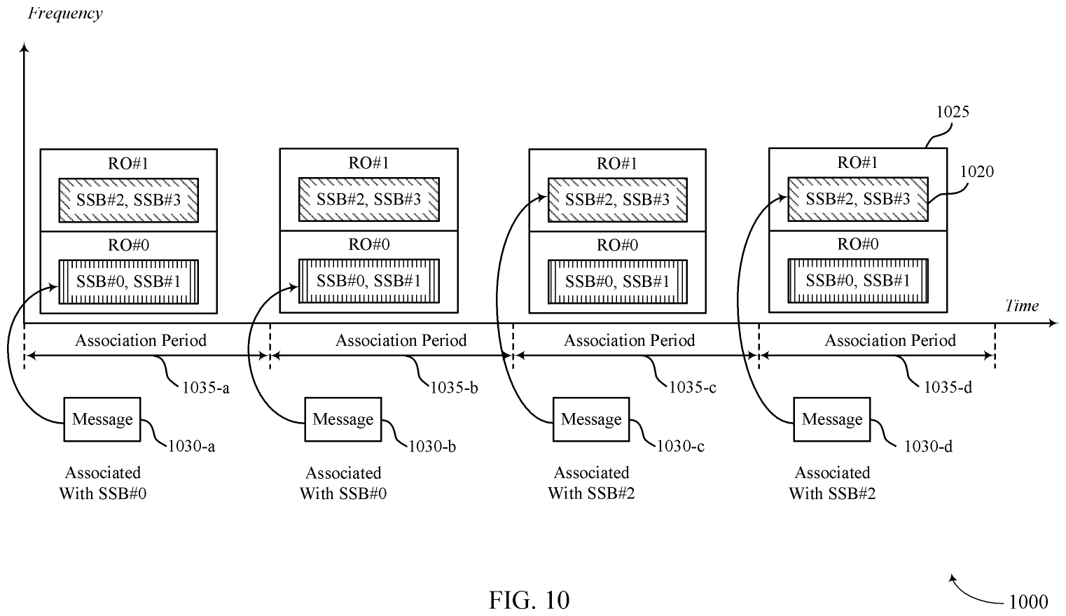

FIG. 10 illustrates an example of a random access multiplexing pattern 1000 that supports multiplexing random access transmissions with different spatial filters in accordance with one or more aspects of the present disclosure. The random access multiplexing pattern 1000 may implement or be implemented by aspects of the wireless communications systems 100 or 200, as described with reference to FIGS. 1 and 2. For example, the random access multiplexing pattern 1000 illustrates an example pattern for multiplexing multiple instances 1030 of a random access message (e.g., PRACH repetitions) by a network node. The random access multiplexing pattern 1000 illustrates two random access occasions 1025 (e.g., ROs #0 and #1) that are mapped to four SSBs 1020 (e.g., SSBs #0 through #3) within each of the association periods 1035-a, 1035-b, 1035-c, and 1035-d. The random access occasions 1025, the SSBs 1020, and the association periods 1035 may represent examples of corresponding components or elements as described with reference to FIGS. 2 through 9.

The mapping between SSBs 1020 and random access occasions 1025 in the random access message multiplexing pattern 1000 may be the same as or similar to the mapping illustrated in the random access occasion configuration 500 described with reference to FIG. 5. For example, two SSBs 1020 may be mapped to a single random access occasion 1025, two random access occasions 1025 may occur at a time, and four SSBs 1020 may be mapped to random access occasions 1025 within each association period 1035.

In the example of FIG. 10, the network node may detect that a first measured signal strength of the SSB #0 and a second measured signal strength of the SSB #2 exceed a threshold value. The network node may detect that measured signal strengths of the SSBs #1 and #3 do not exceed the threshold value. The SSB #0 may be associated with a first spatial filter and mapped to the random access occasion #0. The SSB #2 may be associated with a second spatial filter and mapped to the random access occasion #1, such that transmissions corresponding to the SSBs #0 and #2 may overlap in time.

The network node may be scheduled to transmit four instances 1030 of a random access message. In some aspects, a first quantity of two instances 1030 may be associated with the first spatial filter and a second quantity of two instances 1030 may be associated with the second spatial filter. That is, the network node may be configured to transmit a same quantity of PRACH transmissions for each different spatial filter. FIG. 10 illustrates an example in which the network node may apply the first multiplexing pattern to multiplex all four instances 1030 of the random access message using both spatial filters over time. For example, the network node may transmit each of the first quantity of instances 1030 using the first spatial filter first, before transmitting each of the second quantity of instances 1030 using the second spatial filter.

The network node may transmit the instances 1030-a and 1030-b via the random access occasion #0 in each of the first association period 1035-a and the second association period 1035-b, respectively, using the first spatial filter associated with the SSB #0. The network node may not have any more instances 1030 to transmit using the first spatial filter after the association period 1035-b (e.g., each of the two instances 1030 scheduled per the first spatial filter may be transmitted). In accordance with the rule and the first multiplexing pattern, the network node may subsequently transmit the remaining instances 1030-c and 1030-d via the random access occasion #1 in each of the third association period 1035-c and the fourth association period 1035-d using the second spatial filter associated with the SSB #2. The network node may thereby transmit a total of four instances 1030 of the random access message using two spatial filters based on the first multiplexing pattern.

In some aspects, the network node may be configured to transmit different quantities of instances 1030 per spatial filter. In such cases, the network node may transmit a first quantity of instances 1030 using the first spatial filter and during available random access occasions 1025 that are associated with the first spatial filter first. The network node may subsequently transmit the remaining quantity of instances 1030 using the second spatial filter and during available random access occasions 1025 that are associated with the second spatial filter. If, for example, the network node determines or receives an indication that a first quantity of instances 1030 associated with the first spatial filter includes three instances 1030 and a second quantity of instances 1030 associated with the second spatial filter includes one instance 1030, the network node may use the first spatial filter to transmit the three instances 1030-a through 1030-c via the random access occasion #0 during each of the association periods 1035-a, 1035-b, and 1035-c before using the second spatial filter to transmit the remaining instance 1030-d via the random access occasions #1 during the association period 1035-d.

The network node may begin transmissions according to the first multiplexing pattern using either the first spatial filter or the second spatial filter. In some aspects, the rule or the multiplexing pattern may indicate which spatial filter the pattern should begin with, or the network node may select the SSB and corresponding spatial filter to start the multiplexing pattern randomly or based on one or more parameters, as described with reference to FIG. 8.

In the example of FIG. 10, if the network node detects any combination of two or more SSBs 1020 that exceed the threshold value, the SSBs 1020 will map to either a same random access occasion 1025 or to random access occasions 1025 that at least partially overlap in time. As such, the network node may utilize the first multiplexing pattern for multiplexing transmissions based on any combination of the SSBs #0 through #3.

FIG. 11 illustrates an example of a random access multiplexing pattern 1100 that supports multiplexing random access transmissions with different spatial filters in accordance with one or more aspects of the present disclosure. The random access multiplexing pattern 1100 may implement or be implemented by aspects of the wireless communications systems 100 or 200, as described with reference to FIGS. 1 and 2. For example, the random access multiplexing pattern 1100 illustrates an example pattern for multiplexing multiple instances 1130 of a random access message (e.g., PRACH repetitions) by a network node. The random access multiplexing pattern 1100 illustrates eight random access occasions 1125 (e.g., ROs #0 through #7) that are mapped to four SSBs 1120 (e.g., SSBs #0 through #3) within each of the association periods 1135-a, 1135-b, 1135-c, and 1135-d. The random access occasions 1125, the SSBs 1120, and the association periods 1135 may represent examples of corresponding components or elements as described with reference to FIGS. 2 through 10.

The mapping between SSBs 1120 and random access occasions 1125 in the random access multiplexing pattern 1100 may be the same as or similar to the mapping illustrated in the random access multiplexing pattern 800 described with reference to FIG. 8. For example, a single SSB 1120 may be mapped to two random access occasions 1125, four random access occasions 1125 may occur at a time, and four SSBs 1120 may be mapped to random access occasions 1125 within each association period 1135.

In the example of FIG. 11, the network node may detect that a first measured signal strength of the SSB #0 and a second measured signal strength of the SSB #1 exceed a threshold value. The network node may detect that measured signal strengths of the SSBs #2 and #3 do not exceed the threshold value. The SSB #0 may be associated with a first spatial filter and mapped to the random access occasions #0 and #1. The SSB #1 may be associated with a second spatial filter and mapped to the random access occasions #2 and #3, which may overlap in time with the random access occasions #0 and #1.

The network node may be scheduled to transmit eight instances 1130 of a random access message. In some aspects, a first quantity of four instances 1130 may be associated with the first spatial filter and a second quantity of four instances 1130 may be associated with the second spatial filter. That is, the network node may be configured to transmit a same quantity of PRACH transmissions for each different spatial filter.

FIG. 11 illustrates an example in which the network node may apply the second multiplexing pattern to multiplex all eight instances 1130 of the random access message using both spatial filters over time. For example, the network node may transmit the first quantity of instances 1130 using the first spatial filter and the second quantity of instances 1130 using the second spatial filter in an interleaved pattern. Although the network node switches between spatial filters in every other association period 1135 in the example of FIG. 11, it is to be understood that the second multiplexing pattern may indicate any periodicity for alternating between spatial filters (e.g., every three association periods 1135, or any other quantity of association periods 1135).

The network node may transmit the instances 1130-a and 1130-b via the random access occasions #0 and #1, respectively, in the first association period 1135-a using the first spatial filter. The network node may subsequently switch to using the second spatial filter to transmit the instances 1130-c and 1130-d via the random access occasions #2 and #3, respectively, in the second association period 1135-b. The network node may alternate back to using the first spatial filter in accordance with the rule and the second multiplexing pattern to transmit the instances 1130-e and 1130-f via the random access occasions #0 and #1, respectively, in the third association period 1135-c. The network node may subsequently use the second spatial filter to transmit the remaining instances 1130-g and 1130-h via the random access occasions #2 and #3, respectively, in the fourth association period 1135-d. The network node may thereby alternate between two spatial filters for transmission a total of eight instances 1130 of the random access message based on the second multiplexing pattern.

In some aspects, the network node may be configured to transmit different quantities of instances 1130 per spatial filter. In such cases, the network node may alternate between using the first and second spatial filter during each association period 1135 until the network node transmits all of the scheduled quantity of instances 1130 for one of the spatial filters, at which point the network node may transmit the remaining quantity of instances 1130 using the other spatial filter. For example, if the network node determines or receives an indication that a first quantity of instances 1130 associated with the first spatial filter includes six instances 1130 and a second quantity of instances 1130 associated with the second spatial filter includes two instances 1130 (not pictured in FIG. 11), the network node may alternate between spatial filters as described above during the association periods 1135-a and 1135-b. After transmitting all two of the second quantity of instances 1130 using the second spatial filter during the association period 1135-b, the network node may transmit, in the next consecutive association periods 1135-c and 1135-d, the remaining quantity of instances 1130 using the first spatial filter via the random access occasions #0 and #1 without alternating.

The network node may begin transmissions according to the second multiplexing pattern using either the first spatial filter or the second spatial filter. In some aspects, the rule or the multiplexing pattern may indicate which spatial filter the pattern should begin with. For example, the multiplexing pattern may indicate that a spatial filter associated with an SSB having a highest or lowest index value, or with an SSB having a highest or lowest signal strength measurement should be selected. Additionally or alternatively, the network node may select the SSB and corresponding spatial filter to start the multiplexing pattern randomly or based on one or more parameters. In some aspects, the network node may select the spatial filter based on a quantity of instances 1130 associated with the spatial filter or based on a complexity or power consumption associated with transmissions using the spatial filter.

In some aspects (not illustrated in FIG. 11), the network node may detect that the SSB #0 and the SSB #2 exceed the threshold signal strength value, or any two or more SSBs 1120 that correspond to random access occasions 1125 that do not overlap in time. In such cases, the network node may utilize the second multiplexing pattern for transmission of the scheduled quantity of instances 1130 in fewer association periods 1135 (e.g., half as many) as compared with transmissions associated with overlapping time resources.

For example, during the first association period 1135-a, the network node may transmit two instances within the random access occasions #0 and #1 using the first spatial filter associated with the SSB #0 and two instances within the random access occasions #4 and #5 and using a third spatial filter associated with the SSB #2. Similarly, during the second association period 1135-b, the network node may transmit two instances within the random access occasions #0 and #1 using the first spatial filter and two instances within the random access occasions #4 and #5 and using the third spatial filter. The network node may thereby follow the second multiplexing pattern to transmit the eight scheduled instances using two spatial filters in an interleaved fashion within two association periods 1135.

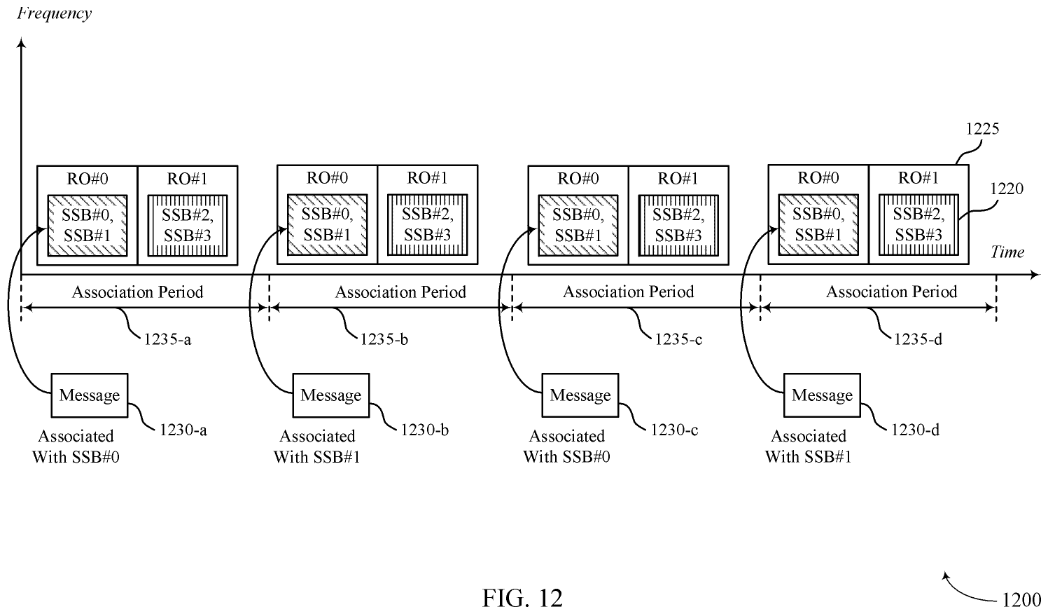

FIG. 12 illustrates an example of a random access multiplexing pattern 1200 that supports multiplexing random access transmissions with different spatial filters in accordance with one or more aspects of the present disclosure. The random access multiplexing pattern 1200 may implement or be implemented by aspects of the wireless communications systems 100 or 200, as described with reference to FIGS. 1 and 2. For example, the random access multiplexing pattern 1200 illustrates an example pattern for multiplexing multiple instances 1230 of a random access message (e.g., PRACH repetitions) by a network node. The random access multiplexing pattern 1200 illustrates two random access occasions 1225 (e.g., ROs #0 and #1) that are mapped to four SSBs 1220 (e.g., SSBs #0 through #3) within each of the association periods 1235-a, 1235-b, 1235-c, and 1235-d. The random access occasions 1225, the SSBs 1220, and the association periods 1235 may represent examples of corresponding components or elements as described with reference to FIGS. 2 through 11.

The mapping between SSBs 1220 and random access occasions 1225 in the random access multiplexing pattern 1200 may be the same as or similar to the mapping illustrated in the random access multiplexing pattern 900 described with reference to FIG. 9. For example, two SSBs 1220 may be mapped to a single random access occasion 1225, one random access occasion 1225 may occur at a time, and four SSBs 1220 may be mapped to random access occasions 1225 within each association period 1235.

In the example of FIG. 12, the network node may detect that a first measured signal strength of the SSB #0 and a second measured signal strength of the SSB #1 exceed a threshold value. The network node may detect that measured signal strengths of the SSBs #2 and #3 do not exceed the threshold value. The SSB #0 may be associated with a first spatial filter and mapped to the random access occasion #0. The SSB #1 may be associated with a second spatial filter and mapped to the random access occasion #0, such that transmissions corresponding to the SSBs #0 and #1 may overlap in time (and, in some aspects, frequency).

The network node may be scheduled to transmit four instances 1230 of a random access message. In some aspects, a first quantity of two instances 1230 may be associated with the first spatial filter and a second quantity of two instances 1230 may be associated with the second spatial filter. That is, the network node may be configured to transmit a same quantity of PRACH transmissions for each different spatial filter.

FIG. 12 illustrates an example in which the network node may apply the second multiplexing pattern to multiplex all four instances 1230 of the random access message using both spatial filters over time. For example, the network node may transmit the first quantity of instances 1230 using the first spatial filter and the second quantity of instances 1230 using the second spatial filter in an interleaved pattern. Although the network node switches between spatial filters in every other association period 1235 in the example of FIG. 12, it is to be understood that the second multiplexing pattern may indicate any periodicity for alternating between spatial filters (e.g., every three association periods 1235, or any other quantity of association periods 1235).

The network node may use the first spatial filter to transmit the instance 1230-a via the random access occasion #0 in the first association period 1235-a. The network node may alternate, or switch, to using the second spatial filter (e.g., a beam switch) to transmit the instance 1230-b via the random access occasion #0 in the second association period 1235-b. In accordance with the rule and the second multiplexing pattern, the network node may continue transmissions in an interleaved or alternating fashion until the four scheduled instances 1230 are transmitted. The network node may alternate back to using the first spatial filter to transmit the instance 1230-c via the random access occasion #0 in the third association period 1235-b. The network node may use the second spatial filter to transmit the instance 1230-d via the random access occasion #0 in the fourth association period 1235-d. The network node may thereby transmit a total of four instances 1230 of the random access message using two spatial filters based on the second multiplexing pattern.

In some aspects, the network node may be configured to transmit different quantities of instances 1230 per spatial filter. In such cases, the network node may alternate between using the first and second spatial filter during each association period 1235 until the network node transmits all of the one of the quantity of instances 1230 (whichever spatial filter is associated with or allocated fewer instances 1230), at which point the network node may transmit remaining instances 1230 using the other spatial filter. If, for example, the network node determines or receives an indication that a first quantity of instances 1230 associated with the first spatial filter includes three instances and a second quantity of instances associated with the second spatial filter includes one instance (not pictured in FIG. 12), the network node may alternate between the first and second spatial filters during the first and second association periods 1235-a and 1235-b, as described above. The network node may transmit all of the scheduled transmissions per the second spatial filter during the second association period 1235-b, and the network node may transmit the remaining instances 1230-c and 1230-d using the first spatial filter in the association periods 1235-c and 1235-d without alternating.

The network node may begin transmissions according to the second multiplexing pattern using either the first spatial filter or the second spatial filter. In some aspects, the rule or the multiplexing pattern may indicate which spatial filter the pattern should begin with, or the network node may select the SSB and corresponding spatial filter to start the multiplexing pattern randomly or based on one or more parameters, as described with reference to FIG. 11.

In some aspects (not illustrated in FIG. 12), the network node may detect that the SSB #0 and the SSB #2 exceed the threshold signal strength value, or any two or more SSBs 1220 that correspond to random access occasions 1225 that do not overlap in time. In such cases, the network node may utilize the second multiplexing pattern for transmission of the scheduled quantity of instances 1230 in fewer association periods 1235 (e.g., half as many) as compared with transmissions associated with overlapping time resources.

For example, during the first association period 1235-a, the network node may transmit one instance 1230 within the random access occasion #0 using the first spatial filter associated with the SSB #0 and one instance 1230 within the random access occasion #1 and using a third spatial filter associated with the SSB #2. Similarly, during the second association period 1235-b, the network node may transmit one instance 1230 within the random access occasion #0 using the first spatial filter and one instance within the random access occasion #1 and using the third spatial filter. The network node may thereby follow the second multiplexing pattern to transmit the four scheduled instances 1230 using two spatial filters in an interleaved fashion within two association periods 1235.

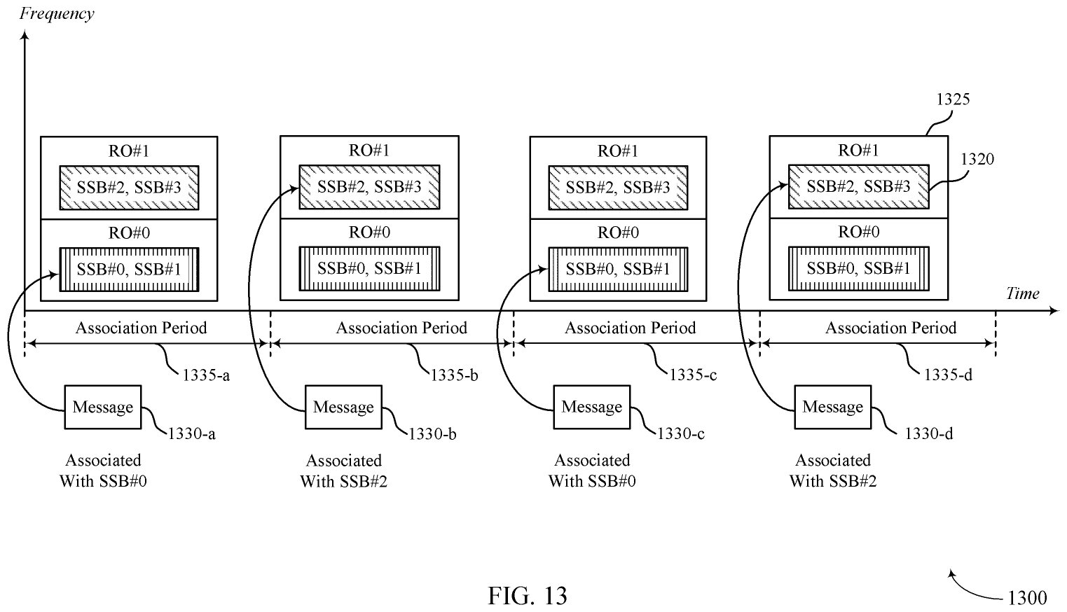

FIG. 13 illustrates an example of a random access multiplexing pattern 1300 that supports multiplexing random access transmissions with different spatial filters in accordance with one or more aspects of the present disclosure. The random access multiplexing pattern 1300 may implement or be implemented by aspects of the wireless communications systems 100 or 200, as described with reference to FIGS. 1 and 2. For example, the random access multiplexing pattern 1300 illustrates an example pattern for multiplexing multiple instances 1330 of a random access message (e.g., PRACH repetitions) by a network node. The random access multiplexing pattern 1300 illustrates two random access occasions 1325 (e.g., ROs #0 and #1) that are mapped to four SSBs 1320 (e.g., SSBs #0 through #3) within each of the association periods 1335-a, 1335-b, 1335-c, and 1335-d. The random access occasions 1325, the SSBs 1320, and the association periods 1335 may represent examples of corresponding components or elements as described with reference to FIGS. 2 through 12.

The mapping between SSBs 1320 and random access occasions 1325 in the random access multiplexing pattern 1300 may be the same as or similar to the mapping illustrated in the random access multiplexing pattern 1000 described with reference to FIG. 10. For example, two SSBs 1320 may be mapped to a single random access occasion 1325, two random access occasions 1325 may occur at a time, and four SSBs 1320 may be mapped to random access occasions 1325 within each association period 1335.

In the example of FIG. 13, the network node may detect that a first measured signal strength of the SSB #0 and a second measured signal strength of the SSB #2 exceed a threshold value. The network node may detect that measured signal strengths of the SSBs #1 and #3 do not exceed the threshold value. The SSB #0 may be associated with a first spatial filter and mapped to the random access occasion #0. The SSB #2 may be associated with a second spatial filter and mapped to the random access occasion #1, such that transmissions corresponding to the SSBs #0 and #2 may overlap in time.

The network node may be scheduled to transmit four instances 1330 of a random access message. In some aspects, a first quantity of two instances 1330 may be associated with the first spatial filter and a second quantity of two instances 1330 may be associated with the second spatial filter. That is, the network node may be configured to transmit a same quantity of PRACH transmissions for each different spatial filter.

FIG. 13 illustrates an example in which the network node may apply the second multiplexing pattern to multiplex all four instances 1330 of the random access message using both spatial filters over time. For example, the network node may transmit the first quantity of instances 1330 using the first spatial filter and the second quantity of instances 1330 using the second spatial filter in an interleaved pattern. Although the network node switches between spatial filters in every other association period 1335 in the example of FIG. 13, it is to be understood that the second multiplexing pattern may indicate any periodicity for alternating between spatial filters (e.g., every three association periods 1335, or any other quantity of association periods 1335).

The network node may use the first spatial filter associated with the SSB #0 to transmit the instance 1330-a via the random access occasion #0 in the first association period 1335-a. The network node may alternate, or switch (e.g., a beam switch), to using the second spatial filter associated with the SSB #2 to transmit the instance 1330-b via the random access occasion #1 in the second association period 1335-b. In accordance with the rule and the second multiplexing pattern, the network node may continue transmissions in an interleaved or alternating fashion until the four scheduled instances 1330 are transmitted. The network node may alternate back to using the first spatial filter associated with the SSB #0 to transmit the instance 1330-c via the random access occasion #0 in the third association period 1335-b. The network node may use the second spatial filter associated with the SSB #2 to transmit the instance 1330-d via the random access occasion #1 in the fourth association period 1335-d. The network node may thereby transmit a total of four instances 1330 of the random access message using two spatial filters based on the second multiplexing pattern.

In some aspects, the network node may be configured to transmit different quantities of instances 1330 per spatial filter. In such cases, the network node may alternate between using the first and second spatial filter during each association period 1335 until the network node transmits all of one of the quantities of instances 1330 (whichever spatial filter is associated with fewer instances 1330). If, for example, the network node determines or receives an indication that a first quantity of instances 1330 associated with the first spatial filter includes three instances 1330 and a second quantity of instances 1330 associated with the second spatial filter includes one instance 1330, the network node may alternate between spatial filters during the first and second association periods 1335-a and 1335-b as described above until the network node transmits the one instance 1330 using the second spatial filter. The network node may subsequently transmit the remaining instances 1330 using the first spatial filter and via the corresponding random access occasion #0 during the association periods 1335-c and 1335-d without alternating.

The network node may begin transmissions according to the second multiplexing pattern using either the first spatial filter or the second spatial filter. In some aspects, the rule or the multiplexing pattern may indicate which spatial filter the pattern should begin with, or the network node may select the SSB and corresponding spatial filter to start the multiplexing pattern randomly or based on one or more parameters, as described with reference to FIG. 12.

In the example of FIG. 13, if the network node detects any combination of two or more SSBs 1320 that exceed the threshold value, the SSBs 1320 will map to either a same random access occasion 1325 or to random access occasions 1325 that at least partially overlap in time. As such, the network node may utilize the second multiplexing pattern for multiplexing transmissions based on any combination of the SSBs #0 through #3.

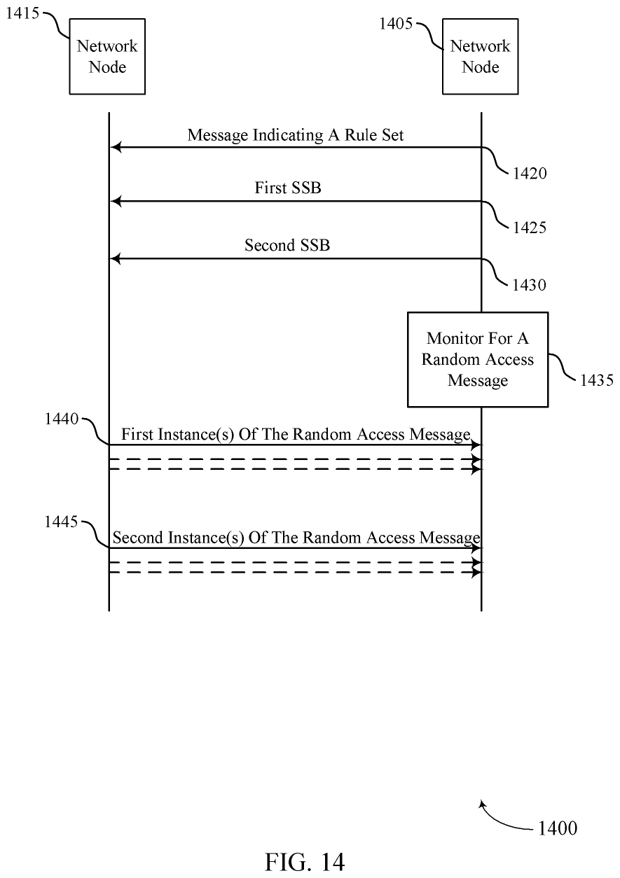

FIG. 14 illustrates an example of a process flow 1400 that supports multiplexing random access transmissions with different spatial filters in accordance with one or more aspects of the present disclosure. The process flow 1400 may implement or be implemented by aspects of the wireless communications systems 100 and 200 described with reference to FIGS. 1 and 2. For example, the process flow 1400 illustrates communications between a first network node 1415 and a second network node 1405, which may represent aspects of corresponding devices or network nodes as described with reference to FIGS. 2 through 13.

In the following description of the process flow 1400, the operations between the network node 1405 and the network node 1415 may be performed in different orders or at different times. Some operations may also be left out of the process flow 1400, or other operations may be added. Although the network node 1415 and a network node 1405 are shown performing the operations of the process flow 1400, some aspects of some operations may also be performed by one or more other wireless devices.

At 1420, the network node 1405 may transmit a message to the network node 1415 to indicate a rule set for random access multiplexing by the first network node 1415 when random access occasions associated with different spatial filters to be used for random access messages overlap in time. The rule set may indicate one or more rules, parameters, and/or patterns for random access multiplexing, as described with reference to FIGS. 2 through 13.

At 1425, the network node 1405 may transmit a first SSB to the network node 1415. The first SSB may be associated with (e.g., transmitted using) a first spatial filter and may be associated with a first set of one or more random access occasions within a respective instance of a random access window, such as within a respective association period, as described with reference to FIGS. 2 through 13.

At 1430, the network node 1405 may transmit a second SSB to the network node 1415. The second SSB may be associated with (e.g., transmitted using) a second spatial filter that is different from the first spatial filter and may be associated with a second set of one or more random access occasions. The first set of one or more random access occasions and the second set of one or more random access occasions may at least partially overlap in time during the respective instance of the random access occasion window.

At 1435, the network node 1405 may monitor, during one or more instances of the random access occasion window, for one or more instances of a random access message. The network node 1405 may monitor for the one or more instances of the random access message using one or more of the first spatial filter and the first set of one or more random access occasions or the second spatial filter and the second set of one or more random access occasions.

At 1440, the network node 1415 may transmit, during a first instance of the random access occasion window, one or more first instances of the random access message using the first spatial filter and the first set of one or more random access occasions to the network node 1405.

At 1445, the network node 1415 may transmit, during a second instance of the random access occasion window, one or more additional instances of the random access message using one or more of the first spatial filter and the first set of one or more random access occasions or the second spatial filter and the second set of one or more random access occasions. Which spatial filter and set of random access occasions is used for transmitting the one or more additional instances of the random access message may be based on the rule set for random access multiplexing when random access occasions associated with different spatial filters to be used for random access message transmissions overlap in time.

In some aspects, the rule set may be that each instance of the random access message is to be transmitted using a same spatial filter, as described with reference to FIG. 6. The network node 1415 may transmit the one or more additional instances using the first spatial filter and the first set of one or more random access messages accordingly. In some other aspects, the rule set may be that different instances of the random access message are to be transmitted using different spatial filters. In such cases, the rule set, the message transmitted at 1420, or some other message may specify a TDM pattern for transmitting the one or more additional instances of the random access message. The TDM pattern may represent an example of the TDM patterns described with reference to FIGS. 8 through 13, as well as any other patterns for multiplexing transmissions over time.

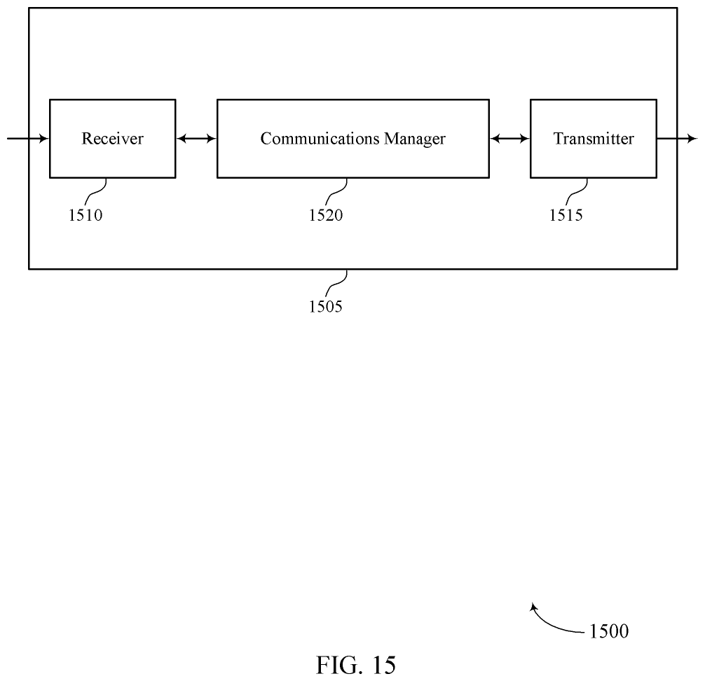

FIG. 15 shows a block diagram 1500 of a device 1505 that supports multiplexing random access transmissions with different spatial filters in accordance with one or more aspects of the present disclosure. The device 1505 may be an example of aspects of a UE 115 or a network node as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to multiplexing random access transmissions with different spatial filters). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to multiplexing random access transmissions with different spatial filters). In some aspects, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of multiplexing random access transmissions with different spatial filters as described herein. For example, the communications manager 1520, the receiver 1510, the transmitter 1515, or various combinations or components thereof may support a method for performing one or more of the functions described herein.

In some aspects, the communications manager 1520, the receiver 1510, the transmitter 1515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

For example, the communications manager 1520 may be configured as or otherwise support a means for receiving a first SSB associated with a first spatial filter and with a first set of one or more random access occasions within a respective instance of a random access occasion window. The communications manager 1520 may be configured as or otherwise support a means for receiving a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The communications manager 1520 may be configured as or otherwise support a means for transmitting, during a first instance of the random access occasion window, one or more first instances of a random access message using the first spatial filter and the first set of one or more random access occasions. The communications manager 1520 may be configured as or otherwise support a means for transmitting, during one or more additional instances of the random access occasion window, one or more additional instances of the random access message using, based on a rule set for random access message multiplexing when random access occasions associated with different spatial filters to be used for random access message transmissions overlap in at least one of time or frequency, one or more of: the first spatial filter and the first set of one or more random access occasions or the second spatial filter and the second set of one or more random access occasions.

By including or configuring the communications manager 1520 in accordance with examples as described herein, the device 1505 (e.g., a processor controlling or otherwise coupled with the receiver 1510, the transmitter 1515, the communications manager 1520, or a combination thereof) may support techniques for reduced processing, reduced power consumption, and more efficient utilization of communication resources. By determining which spatial filter to use for transmitting instances of a random access message based on a configured set of rules, the device 1505 may reduce processing and perform more reliable and efficient transmissions, which may reduce power consumption and improve utilization of communication resources.

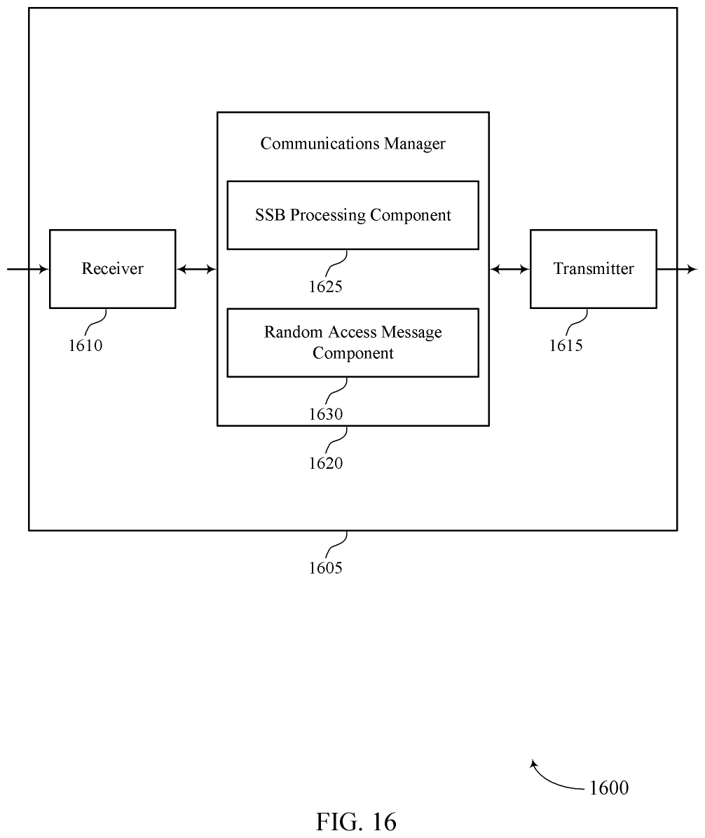

FIG. 16 shows a block diagram 1600 of a device 1605 that supports multiplexing random access transmissions with different spatial filters in accordance with one or more aspects of the present disclosure. The device 1605 may be an example of aspects of a device 1505 or a UE 115 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to multiplexing random access transmissions with different spatial filters). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to multiplexing random access transmissions with different spatial filters). In some aspects, the transmitter 1615 may be co-located with a receiver 1610 in a transceiver module. The transmitter 1615 may utilize a single antenna or a set of multiple antennas.

The device 1605, or various components thereof, may be an example of means for performing various aspects of multiplexing random access transmissions with different spatial filters as described herein. For example, the communications manager 1620 may include an SSB processing component 1625 a random access message component 1630, or any combination thereof. The communications manager 1620 may be an example of aspects of a communications manager 1520 as described herein. In some aspects, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The SSB processing component 1625 may be configured as or otherwise support a means for receiving a first SSB associated with a first spatial filter and with a first set of one or more random access occasions within a respective instance of a random access occasion window. The SSB processing component 1625 may be configured as or otherwise support a means for receiving a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The random access message component 1630 may be configured as or otherwise support a means for transmitting, during a first instance of the random access occasion window, one or more first instances of a random access message using the first spatial filter and the first set of one or more random access occasions. The random access message component 1630 may be configured as or otherwise support a means for transmitting, during one or more additional instances of the random access occasion window, one or more additional instances of the random access message using, based on a rule set for random access message multiplexing when random access occasions associated with different spatial filters to be used for random access message transmissions overlap in at least one of time or frequency, one or more of: the first spatial filter and the first set of one or more random access occasions or the second spatial filter and the second set of one or more random access occasions.

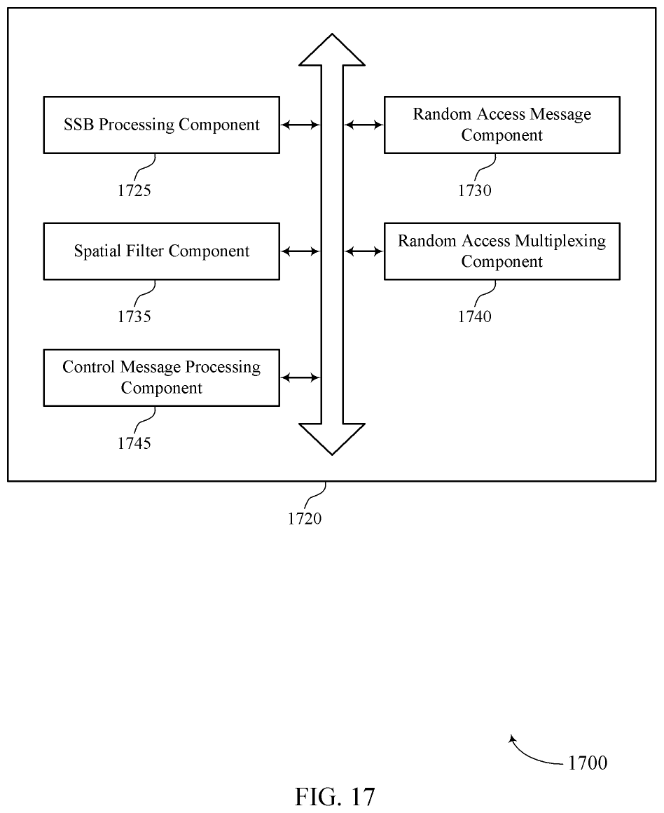

FIG. 17 shows a block diagram 1700 of a communications manager 1720 that supports multiplexing random access transmissions with different spatial filters in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of multiplexing random access transmissions with different spatial filters as described herein. For example, the communications manager 1720 may include an SSB processing component 1725, a random access message component 1730, a spatial filter component 1735, a random access multiplexing component 1740, a control message processing component 1745, or any combination thereof. Each of these components may communicate, directly or indirectly, with one another (e.g., via one or more buses).

The SSB processing component 1725 may be configured as or otherwise support a means for receiving a first SSB associated with a first spatial filter and with a first set of one or more random access occasions within a respective instance of a random access occasion window. In some aspects, the SSB processing component 1725 may be configured as or otherwise support a means for receiving a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The random access message component 1730 may be configured as or otherwise support a means for transmitting, during a first instance of the random access occasion window, one or more first instances of a random access message using the first spatial filter and the first set of one or more random access occasions. In some aspects, the random access message component 1730 may be configured as or otherwise support a means for transmitting, during one or more additional instances of the random access occasion window, one or more additional instances of the random access message using, based on a rule set for random access message multiplexing when random access occasions associated with different spatial filters to be used for random access message transmissions overlap in at least one of time or frequency, one or more of: the first spatial filter and the first set of one or more random access occasions, or the second spatial filter and the second set of one or more random access occasions.

In some aspects, to support transmitting the one or more additional instances of the random access message, the spatial filter component 1735 may be configured as or otherwise support a means for transmitting the one or more additional instances of the random access message using the first spatial filter and the first set of one or more random access occasions based on the rule set, where the rule set is that each instance of the random access message is to be transmitted using a same spatial filter.

In some aspects, to support transmitting the one or more additional instances of the random access message, the spatial filter component 1735 may be configured as or otherwise support a means for transmitting the one or more additional instances of the random access message using at least the second spatial filter and at least the second set of one or more random access occasions based on the rule set, where the rule set is that different instances of the random access message are to be transmitted using different spatial filters. In some aspects, the random access multiplexing component 1740 may be configured as or otherwise support a means for multiplexing, in accordance with a TDM pattern specified by the rule set, transmissions of the one or more first instances of the random access message using the first spatial filter with the one or more additional instances of the random access message using the first spatial filter and the second spatial filter.

In some aspects, transmitting the one or more additional instances of the random access message may continue until a sum of a first quantity of the one or more first instances of the random access message associated with the first spatial filter and a second quantity of the one or more additional instances of the random access message associated with the second spatial filter equals a total quantity.

In some aspects, the control message processing component 1745 may be configured as or otherwise support a means for receiving a message that indicates the first quantity and the second quantity, where the message may include an RRC message or a SIB. In some aspects, the control message processing component 1745 may be configured as or otherwise support a means for receiving a message that indicates the total quantity, where the message may include an RRC message or a SIB.

In some aspects, transmitting the one or more first instances of the random access message may include transmitting, in accordance with the rule set, the first quantity of the one or more first instances of the random access message associated with the first spatial filter. In some aspects, transmitting the one or more additional instances of the random access message may include transmitting, in accordance with the rule set, the second quantity of the one or more additional instances of the random access message associated with the second spatial filter after transmission of the first quantity of the one or more first instances of the random access message.

In some aspects, transmitting the one or more first instances of the random access message may include transmitting, in accordance with an interleaving pattern specified by the rule set, the first quantity of instances of the random access message associated with the first spatial filter. In some aspects, transmitting the one or more additional instances of the random access message may include transmitting, in accordance with the interleaving pattern specified by the rule set, the second quantity of the one or more additional instances of the random access message associated with the second spatial filter, the one or more additional instances of the random access message interleaved with the one or more first instances of the random access message in time based on interleaving pattern.

In some aspects, the first quantity may equal the second quantity. In some aspects, the first quantity and the second quantity may be different.

In some aspects, the control message processing component 1745 may be configured as or otherwise support a means for receiving a message that indicates the rule set and a pattern specified by the rule set, the pattern including a random access message multiplexing pattern for transmitting the first quantity of instances of the random access message associated with the first spatial filter and the second quantity of instances of the random access message associated with the second spatial filter, where the message may include an RRC message or a SIB.

In some aspects, to support transmitting the one or more first instances of the random access message, the random access multiplexing component 1740 may be configured as or otherwise support a means for transmitting the one or more first instances of the random access message using the first spatial filter and the first set of one or more random access occasions based on a selection of the first spatial filter from a set of multiple spatial filters including at least the first spatial filter and the second spatial filter based on a measurement of the first SSB, based on the rule set, or both.

In some aspects, the first set of one or more random access occasions and the second set of one or more random access occasions may overlap partially or fully in at least one of time or frequency during the respective instance of the random access occasion window.

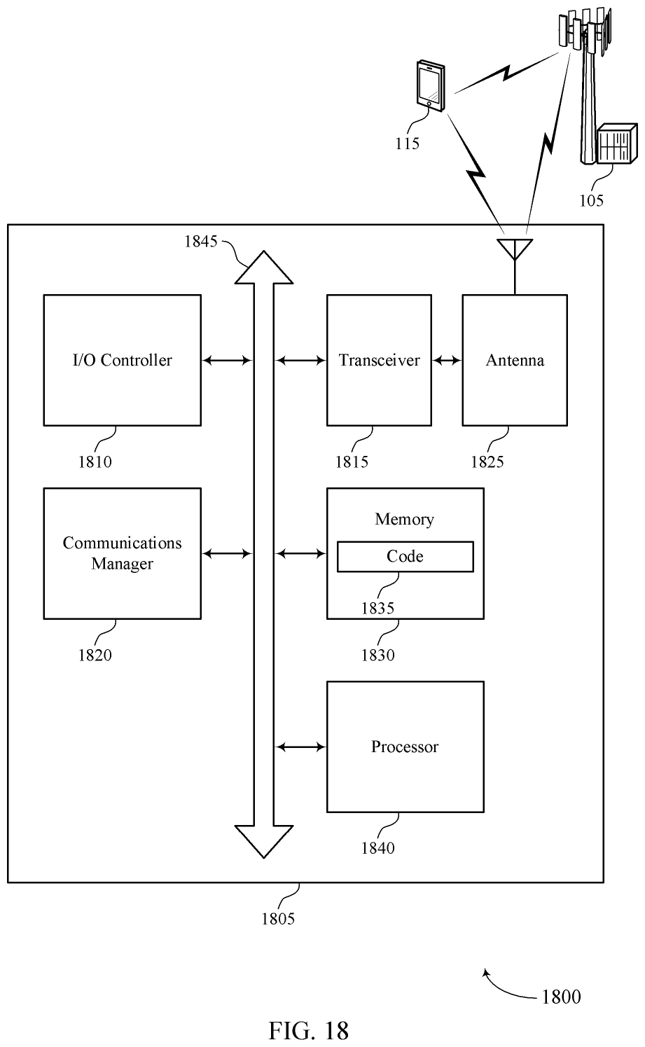

FIG. 18 shows a diagram of a system 1800 including a device 1805 that supports multiplexing random access transmissions with different spatial filters in accordance with one or more aspects of the present disclosure. The device 1805 may be an example of or include the components of a device 1505, a device 1605, or a UE 115 as described herein. The device 1805 may communicate (e.g., wirelessly) with one or more network entities 105, one or more UEs 115, or any combination thereof. The device 1805 may include components for bi-directional voice and data communications including components for transmitting and receiving communications, such as a communications manager 1820, an input/output (I/O) controller 1810, a transceiver 1815, an antenna 1825, a memory 1830, code 1835, and a processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOS®, ANDROID®, MS-DOS®, MS-WINDOWS®, OS/2®, UNIX®, LINUX®, or another known operating system. Additionally or alternatively, the I/O controller 1810 may represent or interact with a modem, a keyboard, a mouse, a touchscreen, or a similar device. In some cases, the I/O controller 1810 may be implemented as part of a processor, such as the processor 1840. In some cases, a user may interact with the device 1805 via the I/O controller 1810 or via hardware components controlled by the I/O controller 1810.

In some cases, the device 1805 may include a single antenna 1825. However, in some other cases, the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The memory 1830 may include random access memory (RAM) and read-only memory (ROM). The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a basic I/O system (BIOS) which may control basic hardware or software operation such as the interaction with peripheral components or devices.

The processor 1840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting multiplexing random access transmissions with different spatial filters). For example, the device 1805 or a component of the device 1805 may include a processor 1840 and memory 1830 coupled with or to the processor 1840, the processor 1840 and memory 1830 configured to perform various functions described herein.

For example, the communications manager 1820 may be configured as or otherwise support a means for receiving a first SSB associated with a first spatial filter and with a first set of one or more random access occasions within a respective instance of a random access occasion window. The communications manager 1820 may be configured as or otherwise support a means for receiving a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The communications manager 1820 may be configured as or otherwise support a means for transmitting, during a first instance of the random access occasion window, one or more first instances of a random access message using the first spatial filter and the first set of one or more random access occasions. The communications manager 1820 may be configured as or otherwise support a means for transmitting, during one or more additional instances of the random access occasion window, one or more additional instances of the random access message using, based on a rule set for random access message multiplexing when random access occasions associated with different spatial filters to be used for random access message transmissions overlap in at least one of time or frequency, one or more of: the first spatial filter and the first set of one or more random access occasions, or the second spatial filter and the second set of one or more random access occasions.

By including or configuring the communications manager 1820 in accordance with examples as described herein, the device 1805 may support techniques for improved communication reliability, reduced latency, reduced power consumption, more efficient utilization of communication resources, and improved coordination between devices.

In some aspects, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some aspects, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of multiplexing random access transmissions with different spatial filters as described herein, or the processor 1840 and the memory 1830 may be otherwise configured to perform or support such operations.

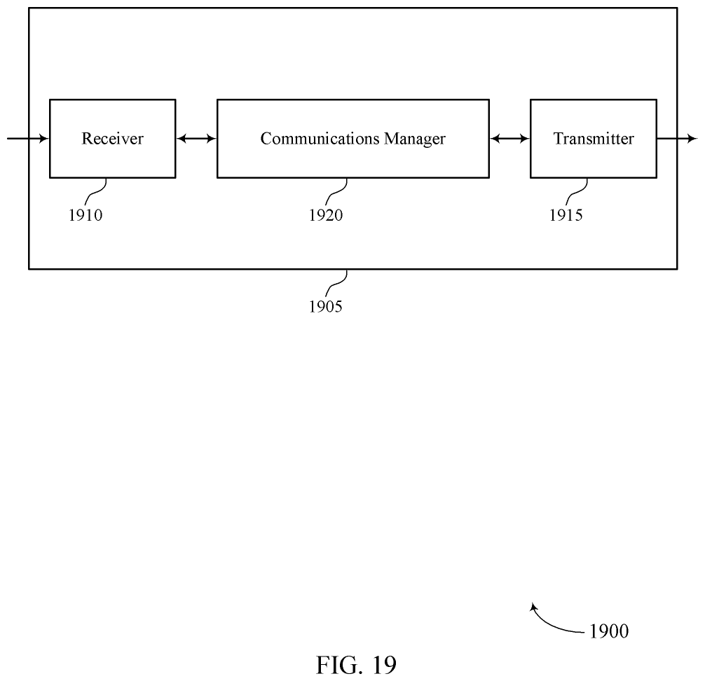

FIG. 19 shows a block diagram 1900 of a device 1905 that supports multiplexing random access transmissions with different spatial filters in accordance with one or more aspects of the present disclosure. The device 1905 may be an example of aspects of a network entity or a network node as described herein. The device 1905 may include a receiver 1910, a transmitter 1915, and a communications manager 1920. The device 1905 may also include a processor. Each of these components may be in communication with one another (e.g., via one or more buses).

The receiver 1910 may provide a means for receiving information such as packets, user data, control information, or any combination thereof associated with various information channels (e.g., control channels, data channels, information channels related to multiplexing random access transmissions with different spatial filters). Information may be passed on to other components of the device 1905. The receiver 1910 may utilize a single antenna or a set of multiple antennas.

The transmitter 1915 may provide a means for transmitting signals generated by other components of the device 1905. For example, the transmitter 1915 may transmit information such as packets, user data, control information, or any combination thereof associated with various information channels (e.g., control channels, data channels, information channels related to multiplexing random access transmissions with different spatial filters). In some aspects, the transmitter 1915 may be co-located with a receiver 1910 in a transceiver module. The transmitter 1915 may utilize a single antenna or a set of multiple antennas.

The communications manager 1920, the receiver 1910, the transmitter 1915, or various combinations thereof or various components thereof may be examples of means for performing various aspects of multiplexing random access transmissions with different spatial filters as described herein. For example, the communications manager 1920, the receiver 1910, the transmitter 1915, or various combinations or components thereof may support a method for performing one or more of the functions described herein.

In some aspects, the communications manager 1920, the receiver 1910, the transmitter 1915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 1920, the receiver 1910, the transmitter 1915, or various combinations or components thereof may be implemented in code (e.g., as communications management software or firmware) executed by a processor. If implemented in code executed by a processor, the functions of the communications manager 1920, the receiver 1910, the transmitter 1915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 1920 may be configured to perform various operations (e.g., receiving, obtaining, monitoring, outputting, transmitting) using or otherwise in cooperation with the receiver 1910, the transmitter 1915, or both. For example, the communications manager 1920 may receive information from the receiver 1910, send information to the transmitter 1915, or be integrated in combination with the receiver 1910, the transmitter 1915, or both to obtain information, output information, or perform various other operations as described herein.

For example, the communications manager 1920 may be configured as or otherwise support a means for transmitting a message that indicates a rule set for random access message multiplexing by a second network node when random access occasions associated with different spatial filters to be used for random access messages overlap in at least one of time or frequency. The communications manager 1920 may be configured as or otherwise support a means for transmitting a first SSB associated with a first spatial filter and with a first set of one or more random access occasions within a respective instance of a random access occasion window. The communications manager 1920 may be configured as or otherwise support a means for transmitting a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The communications manager 1920 may be configured as or otherwise support a means for monitoring, during one or more instances of the random access occasion window, for one or more instances of a random access message using one or more of: the first spatial filter and the first set of one or more random access occasions, or the second spatial filter and the second set of one or more random access occasions.

By including or configuring the communications manager 1920 in accordance with examples as described herein, the device 1905 (e.g., a processor controlling or otherwise coupled with the receiver 1910, the transmitter 1915, the communications manager 1920, or a combination thereof) may support techniques for reduced processing, reduced power consumption, and more efficient utilization of communication resources.

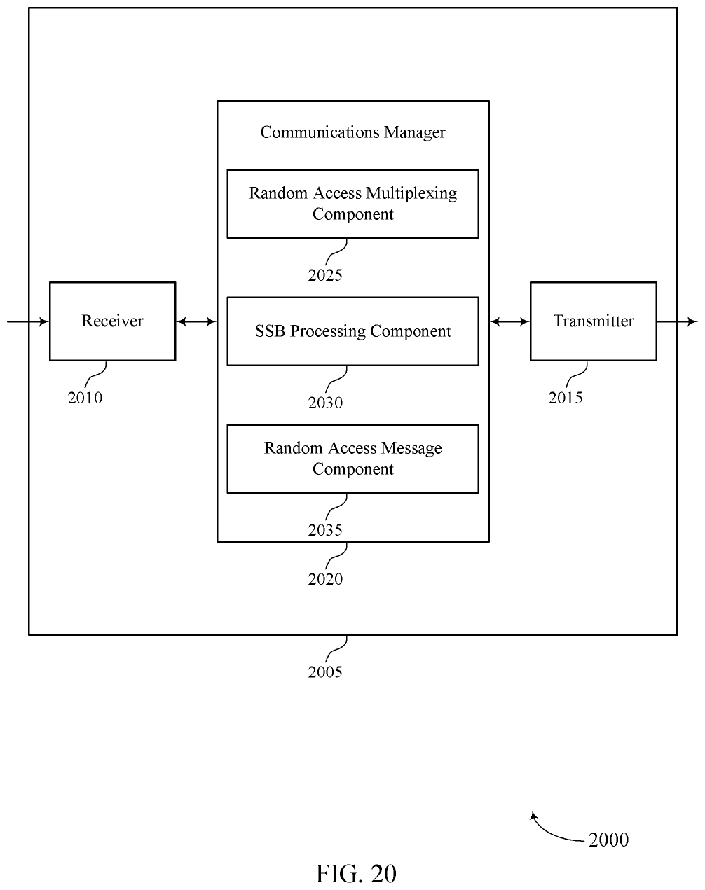

FIG. 20 shows a block diagram 2000 of a device 2005 that supports multiplexing random access transmissions with different spatial filters in accordance with one or more aspects of the present disclosure. The device 2005 may be an example of aspects of a device 1905 or a network node 115 as described herein. The device 2005 may include a receiver 2010, a transmitter 2015, and a communications manager 2020. The device 2005 may also include a processor. Each of these components may be in communication with one another (e.g., via one or more buses).

The receiver 2010 may provide a means for receiving information such as packets, user data, control information, or any combination thereof associated with various information channels (e.g., control channels, data channels, information channels related to multiplexing random access transmissions with different spatial filters). Information may be passed on to other components of the device 2005. The receiver 2010 may utilize a single antenna or a set of multiple antennas.

The transmitter 2015 may provide a means for transmitting signals generated by other components of the device 2005. For example, the transmitter 2015 may transmit information such as packets, user data, control information, or any combination thereof associated with various information channels (e.g., control channels, data channels, information channels related to multiplexing random access transmissions with different spatial filters). In some aspects, the transmitter 2015 may be co-located with a receiver 2010 in a transceiver module. The transmitter 2015 may utilize a single antenna or a set of multiple antennas.

The device 2005, or various components thereof, may be an example of means for performing various aspects of multiplexing random access transmissions with different spatial filters as described herein. For example, the communications manager 2020 may include a random access multiplexing component 2025, an SSB processing component 2030, a random access message component 2035, or any combination thereof. The communications manager 2020 may be an example of aspects of a communications manager 1920 as described herein. In some aspects, the communications manager 2020, or various components thereof, may be configured to perform various operations (e.g., receiving, obtaining, monitoring, outputting, transmitting) using or otherwise in cooperation with the receiver 2010, the transmitter 2015, or both. For example, the communications manager 2020 may receive information from the receiver 2010, send information to the transmitter 2015, or be integrated in combination with the receiver 2010, the transmitter 2015, or both to obtain information, output information, or perform various other operations as described herein.

The random access multiplexing component 2025 may be configured as or otherwise support a means for transmitting a message that indicates a rule set for random access message multiplexing by a second network node when random access occasions associated with different spatial filters to be used for random access messages overlap in at least one of time or frequency. The SSB processing component 2030 may be configured as or otherwise support a means for transmitting a first SSB associated with a first spatial filter and with a first set of one or more random access occasions within a respective instance of a random access occasion window. The SSB processing component 2030 may be configured as or otherwise support a means for transmitting a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The random access message component 2035 may be configured as or otherwise support a means for monitoring, during one or more instances of the random access occasion window, for one or more instances of a random access message using one or more of: the first spatial filter and the first set of one or more random access occasions, or the second spatial filter and the second set of one or more random access occasions.

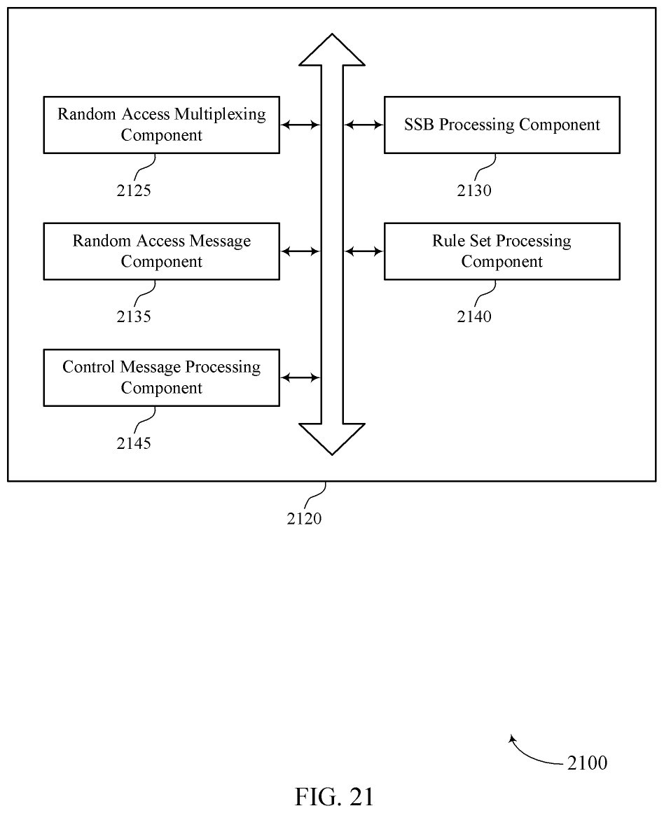

FIG. 21 shows a block diagram 2100 of a communications manager 2120 that supports multiplexing random access transmissions with different spatial filters in accordance with one or more aspects of the present disclosure. The communications manager 2120 may be an example of aspects of a communications manager 1920, a communications manager 2020, or both, as described herein. The communications manager 2120, or various components thereof, may be an example of means for performing various aspects of multiplexing random access transmissions with different spatial filters as described herein. For example, the communications manager 2120 may include a random access multiplexing component 2125, an SSB processing component 2130, a random access message component 2135, a rule set processing component 2140, a control message processing component 2145, or any combination thereof. Each of these components may communicate, directly or indirectly, with one another (e.g., via one or more buses).

The random access multiplexing component 2125 may be configured as or otherwise support a means for transmitting a message that indicates a rule set for random access message multiplexing by a second network node when random access occasions associated with different spatial filters to be used for random access messages overlap in at least one of time or frequency. The SSB processing component 2130 may be configured as or otherwise support a means for transmitting a first SSB associated with a first spatial filter and with a first set of one or more random access occasions within a respective instance of a random access occasion window. In some aspects, the SSB processing component 2130 may be configured as or otherwise support a means for transmitting a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The random access message component 2135 may be configured as or otherwise support a means for monitoring, during one or more instances of the random access occasion window, for one or more instances of a random access message using one or more of: the first spatial filter and the first set of one or more random access occasions, or the second spatial filter and the second set of one or more random access occasions.

In some aspects, to support transmitting the message, the rule set processing component 2140 may be configured as or otherwise support a means for transmitting an indication of the rule set for random access multiplexing to be performed by the second network node, where the rule set is that the second network node transmits each instance of the random access message using a same spatial filter.

In some aspects, to support transmitting the message, the rule set processing component 2140 may be configured as or otherwise support a means for transmitting an indication of the rule set for random access multiplexing to be performed by the second network node, where the rule set is that the second network node transmits instances of the random access message using different spatial filters. In some aspects, the rule set may indicate a TDM pattern for multiplexing transmissions of the one or more instances of the random access message using the first spatial filter and the second spatial filter.

In some aspects, to support transmitting the message, the random access multiplexing component 2125 may be configured as or otherwise support a means for transmitting an indication of a parameter for random access multiplexing, where the parameter indicates a first quantity of instances of the random access message associated with the first spatial filter and a second quantity of instances of the random access message associated with the second spatial filter.

In some aspects, the first quantity may equal the second quantity. In some aspects, the first quantity and the second quantity may be different.

In some aspects, to support transmitting the message, the random access multiplexing component 2125 may be configured as or otherwise support a means for transmitting an indication of a parameter for random access multiplexing, where the parameter may indicate a total quantity of the one or more instances of the random access message for a set of multiple spatial filters including at least the first spatial filter and the second spatial filter.

In some aspects, to support transmitting the message, the rule set processing component 2140 may be configured as or otherwise support a means for transmitting an indication of the rule set for random access multiplexing by the second network node, where the rule set is that the second network node transmits a first quantity of instances of the random access message associated with the first spatial filter and a second quantity of instances of the random access message associated with the second spatial filter after transmitting the first quantity of instances of the random access message.

In some aspects, to support transmitting the message, the rule set processing component 2140 may be configured as or otherwise support a means for transmitting an indication of the rule set for random access multiplexing by the second network node, where the rule set is that the second network node transmits a first quantity of instances of the random access message associated with the first spatial filter and a second quantity of instances of the random access message associated with the second spatial filter in accordance with an interleaving pattern specified by the rule set.

In some aspects, to support transmitting the message, the control message processing component 2145 may be configured as or otherwise support a means for transmitting an RRC message or a SIB that indicates the rule set for random access message multiplexing when random access occasions associated with different spatial filters to be used for random access messages overlap partially or fully in at least one of time or frequency.

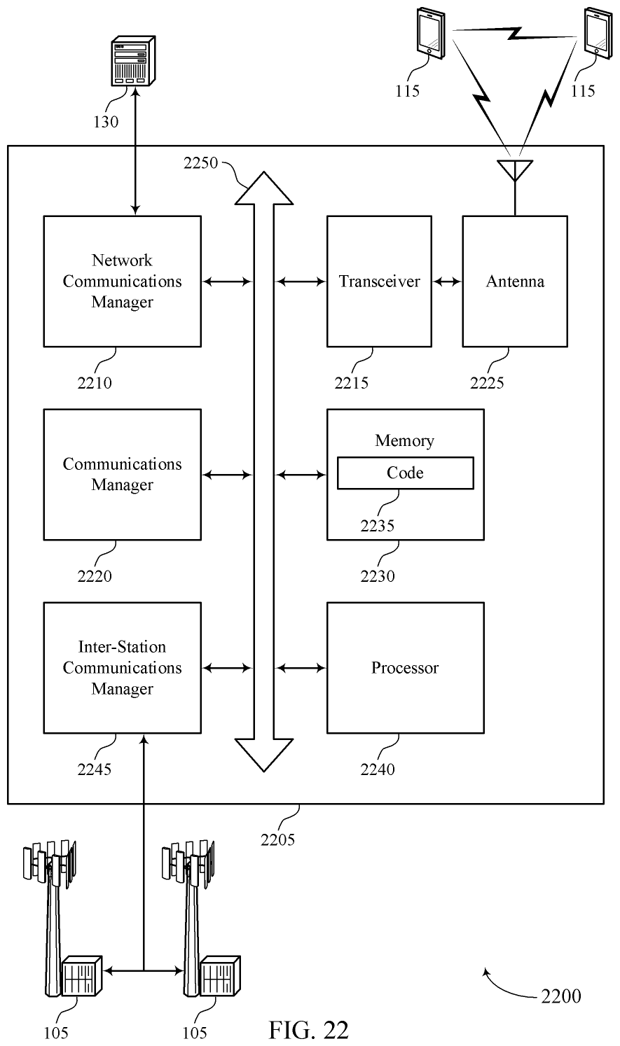

FIG. 22 shows a diagram of a system 2200 including a device 2205 that supports multiplexing random access transmissions with different spatial filters in accordance with one or more aspects of the present disclosure. The device 2205 may be an example of or include the components of a device 1905, a device 2005, a network entity, or a network node as described herein. The device 2205 may include components for bi-directional voice and data communications including components for transmitting and receiving communications, such as a communications manager 2220, a network communications manager 2210, a transceiver 2215, an antenna 2225, a memory 2230, code 2235, a processor 2240, and an inter-station communications manager 2245. These components may be in electronic communication or otherwise coupled (e.g., operatively, communicatively, functionally, electronically, electrically) via one or more buses (e.g., a bus 2250).

The network communications manager 2210 may manage communications with a core network 130 (e.g., via one or more wired backhaul links). For example, the network communications manager 2210 may manage the transfer of data communications for client devices, such as one or more UEs 115.

In some cases, the device 2205 may include a single antenna 2225. However, in some other cases the device 2205 may have more than one antenna 2225, which may be capable of concurrently transmitting or receiving multiple wireless transmissions. The transceiver 2215 may communicate bi-directionally, via the one or more antennas 2225, wired, or wireless links as described herein. For example, the transceiver 2215 may represent a wireless transceiver and may communicate bi-directionally with another wireless transceiver. The transceiver 2215 may also include a modem to modulate the packets, to provide the modulated packets to one or more antennas 2225 for transmission, and to demodulate packets received from the one or more antennas 2225. The transceiver 2215, or the transceiver 2215 and one or more antennas 2225, may be an example of a transmitter 1915, a transmitter 2015, a receiver 1910, a receiver 2010, or any combination thereof or component thereof, as described herein.

The memory 2230 may include RAM and ROM. The memory 2230 may store computer-readable, computer-executable code 2235 including instructions that, when executed by the processor 2240, cause the device 2205 to perform various functions described herein. The code 2235 may be stored in a non-transitory computer-readable medium such as system memory or another type of memory. In some cases, the code 2235 may not be directly executable by the processor 2240 but may cause a computer (e.g., when compiled and executed) to perform functions described herein. In some cases, the memory 2230 may contain, among other things, a BIOS which may control basic hardware or software operation such as the interaction with peripheral components or devices.

The processor 2240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 2240 may be configured to operate a memory array using a memory controller. In some other cases, a memory controller may be integrated into the processor 2240. The processor 2240 may be configured to execute computer-readable instructions stored in a memory (e.g., the memory 2230) to cause the device 2205 to perform various functions (e.g., functions or tasks supporting multiplexing random access transmissions with different spatial filters). For example, the device 2205 or a component of the device 2205 may include a processor 2240 and memory 2230 coupled to the processor 2240, the processor 2240 and memory 2230 configured to perform various functions described herein.

The inter-station communications manager 2245 may manage communications with other base stations 140 or network entities 105, and may include a controller or scheduler for controlling communications with UEs 115 in cooperation with other network entities 105. For example, the inter-station communications manager 2245 may coordinate scheduling for transmissions to UEs 115 for various interference mitigation techniques such as beamforming or joint transmission. In some aspects, the inter-station communications manager 2245 may provide an X2 interface within an LTE/LTE-A wireless communications network technology to provide communication between network entities 105.

For example, the communications manager 2220 may be configured as or otherwise support a means for transmitting a message that indicates a rule set for random access message multiplexing by a second network node when random access occasions associated with different spatial filters to be used for random access messages overlap in at least one of time or frequency. The communications manager 2220 may be configured as or otherwise support a means for transmitting a first SSB associated with a first spatial filter and with a first set of one or more random access occasions within a respective instance of a random access occasion window. The communications manager 2220 may be configured as or otherwise support a means for transmitting a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The communications manager 2220 may be configured as or otherwise support a means for monitoring, during one or more instances of the random access occasion window, for one or more instances of a random access message using one or more of: the first spatial filter and the first set of one or more random access occasions, or the second spatial filter and the second set of one or more random access occasions.

By including or configuring the communications manager 2220 in accordance with examples as described herein, the device 2205 may support techniques for improved communication reliability, reduced latency, reduced power consumption, more efficient utilization of communication resources, and improved coordination between devices, among other advantageous.

In some aspects, the communications manager 2220 may be configured to perform various operations (e.g., receiving, monitoring, transmitting) using or otherwise in cooperation with the transceiver 2215, the one or more antennas 2225, or any combination thereof. Although the communications manager 2220 is illustrated as a separate component, in some aspects, one or more functions described with reference to the communications manager 2220 may be supported by or performed by the processor 2240, the memory 2230, the code 2235, or any combination thereof. For example, the code 2235 may include instructions executable by the processor 2240 to cause the device 2205 to perform various aspects of multiplexing random access transmissions with different spatial filters as described herein, or the processor 2240 and the memory 2230 may be otherwise configured to perform or support such operations.

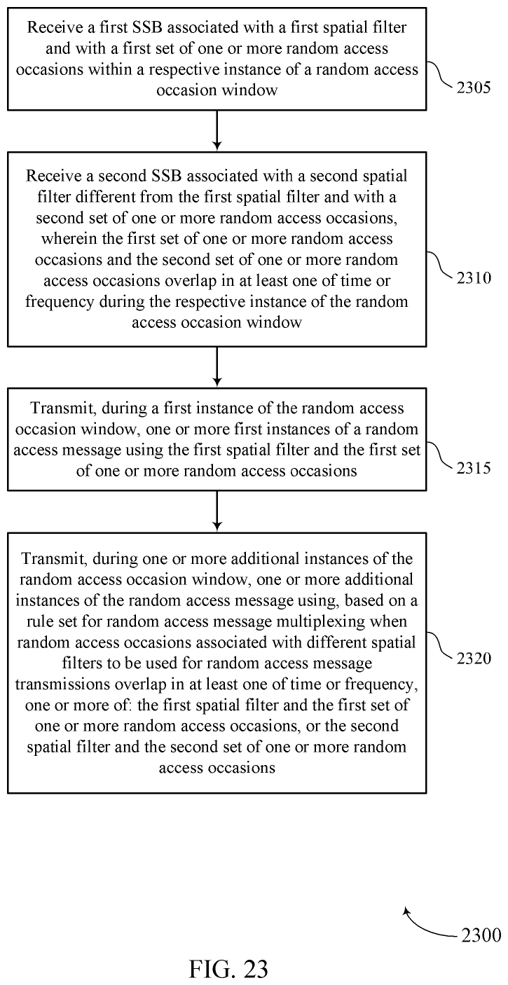

FIG. 23 shows a flowchart illustrating a method 2300 that supports multiplexing random access transmissions with different spatial filters in accordance with one or more aspects of the present disclosure. The operations of the method 2300 may be implemented by a network node or its components as described herein. For example, the operations of the method 2300 may be performed by a UE 115 or some other network node as described with reference to FIGS. 1 through 18. In some aspects, a network node may execute a set of instructions to control the functional elements of the network node to perform the described functions. Additionally, or alternatively, the network node may perform aspects of the described functions using special-purpose hardware.

At 2305, the method may include receiving a first SSB associated with a first spatial filter and with a first set of one or more random access occasions within a respective instance of a random access occasion window. The operations of 2305 may be performed in accordance with examples as disclosed herein. In some aspects, aspects of the operations of 2305 may be performed by an SSB processing component 1725 as described with reference to FIG. 17.

At 2310, the method may include receiving a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The operations of 2310 may be performed in accordance with examples as disclosed herein. In some aspects, aspects of the operations of 2310 may be performed by an SSB processing component 1725 as described with reference to FIG. 17.

At 2315, the method may include transmitting, during a first instance of the random access occasion window, one or more first instances of a random access message using the first spatial filter and the first set of one or more random access occasions. The operations of 2315 may be performed in accordance with examples as disclosed herein. In some aspects, aspects of the operations of 2315 may be performed by a random access message component 1730 as described with reference to FIG. 17.

At 2320, the method may include transmitting, during one or more additional instances of the random access occasion window, one or more additional instances of the random access message using, based on a rule set for random access message multiplexing when random access occasions associated with different spatial filters to be used for random access message transmissions overlap in at least one of time or frequency, one or more of: the first spatial filter and the first set of one or more random access occasions, or the second spatial filter and the second set of one or more random access occasions. The operations of 2320 may be performed in accordance with examples as disclosed herein. In some aspects, aspects of the operations of 2320 may be performed by a random access message component 1730 as described with reference to FIG. 17.

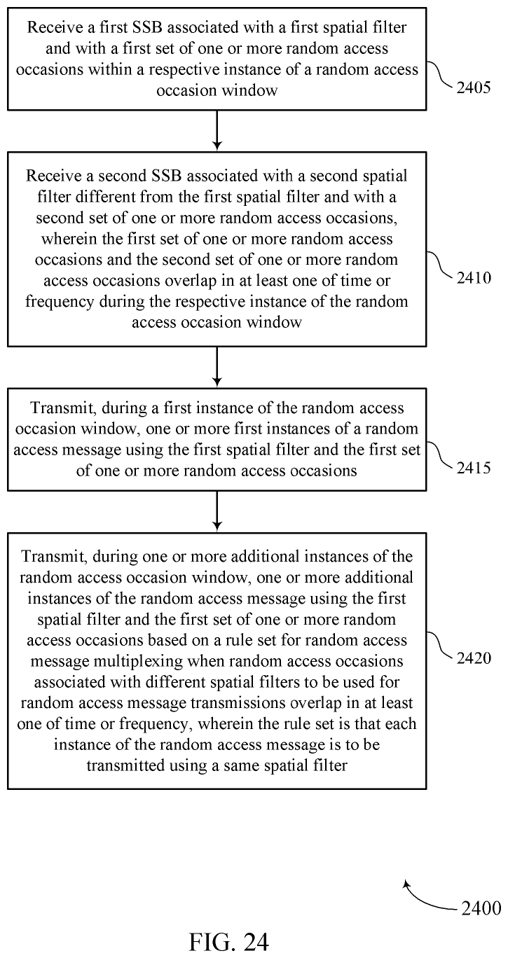

FIG. 24 shows a flowchart illustrating a method 2400 that supports multiplexing random access transmissions with different spatial filters in accordance with one or more aspects of the present disclosure. The operations of the method 2400 may be implemented by a network node or its components as described herein. For example, the operations of the method 2400 may be performed by a UE 115 or some other network node as described with reference to FIGS. 1 through 18. In some aspects, a network node may execute a set of instructions to control the functional elements of the network node to perform the described functions. Additionally, or alternatively, the network node may perform aspects of the described functions using special-purpose hardware.

At 2405, the method may include receiving a first SSB associated with a first spatial filter and with a first set of one or more random access occasions within a respective instance of a random access occasion window. The operations of 2405 may be performed in accordance with examples as disclosed herein. In some aspects, aspects of the operations of 2405 may be performed by an SSB processing component 1725 as described with reference to FIG. 17.

At 2410, the method may include receiving a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The operations of 2410 may be performed in accordance with examples as disclosed herein. In some aspects, aspects of the operations of 2410 may be performed by an SSB processing component 1725 as described with reference to FIG. 17.

At 2415, the method may include transmitting, during a first instance of the random access occasion window, one or more first instances of a random access message using the first spatial filter and the first set of one or more random access occasions. The operations of 2415 may be performed in accordance with examples as disclosed herein. In some aspects, aspects of the operations of 2415 may be performed by a random access message component 1730 as described with reference to FIG. 17.

At 2420, the method may include transmitting, during one or more additional instances of the random access occasion window, one or more additional instances of the random access message using the first spatial filter and the first set of one or more random access occasions based on a rule set for random access message multiplexing when random access occasions associated with different spatial filters to be used for random access message transmissions overlap in at least one of time or frequency, where the rule set is that each instance of the random access message is to be transmitted using a same spatial filter. The operations of 2420 may be performed in accordance with examples as disclosed herein. In some aspects, aspects of the operations of 2420 may be performed by a random access message component 1730 as described with reference to FIG. 17.

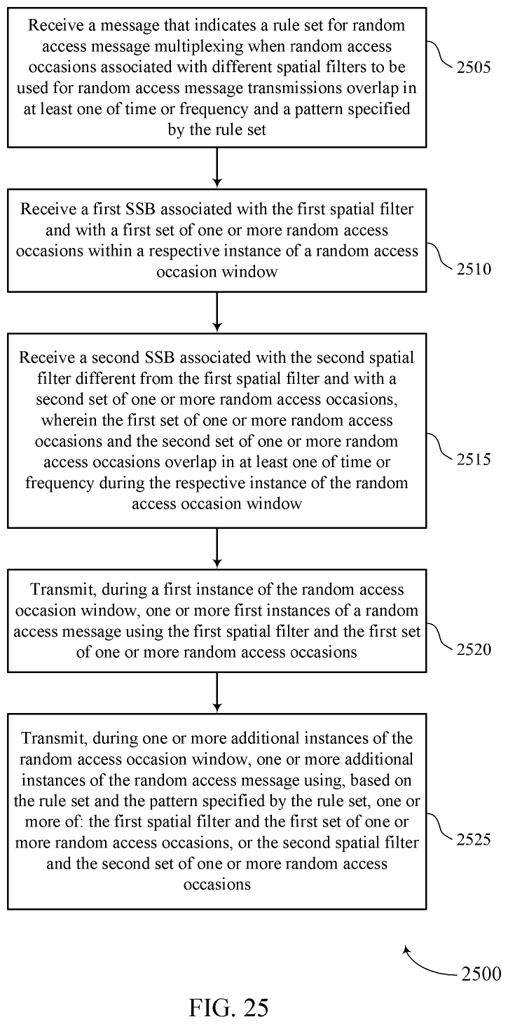

FIG. 25 shows a flowchart illustrating a method 2500 that supports multiplexing random access transmissions with different spatial filters in accordance with one or more aspects of the present disclosure. The operations of the method 2500 may be implemented by a network node or its components as described herein. For example, the operations of the method 2500 may be performed by a UE 115 or some other network node as described with reference to FIGS. 1 through 18. In some aspects, a network node may execute a set of instructions to control the functional elements of the network node to perform the described functions. Additionally, or alternatively, the network node may perform aspects of the described functions using special-purpose hardware.

At 2505, the method may include receiving a message that indicates the rule set for random access message multiplexing when random access occasions associated with different spatial filters to be used for random access message transmissions overlap in at least one of time or frequency and a pattern specified by the rule set. The operations of 2505 may be performed in accordance with examples as disclosed herein. In some aspects, aspects of the operations of 2505 may be performed by a control message processing component 1745 as described with reference to FIG. 17.

At 2510, the method may include receiving a first SSB associated with a first spatial filter and with a first set of one or more random access occasions within a respective instance of a random access occasion window. The operations of 2510 may be performed in accordance with examples as disclosed herein. In some aspects, aspects of the operations of 2510 may be performed by an SSB processing component 1725 as described with reference to FIG. 17.

At 2515, the method may include receiving a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The operations of 2515 may be performed in accordance with examples as disclosed herein. In some aspects, aspects of the operations of 2515 may be performed by an SSB processing component 1725 as described with reference to FIG. 17.

At 2520, the method may include transmitting, during a first instance of the random access occasion window, one or more first instances of a random access message using the first spatial filter and the first set of one or more random access occasions. The operations of 2520 may be performed in accordance with examples as disclosed herein. In some aspects, aspects of the operations of 2520 may be performed by a random access message component 1730 as described with reference to FIG. 17.

At 2525, the method may include transmitting, during one or more additional instances of the random access occasion window, one or more additional instances of the random access message using, based on the rule set and the pattern specified by the rule set, one or more of: the first spatial filter and the first set of one or more random access occasions, or the second spatial filter and the second set of one or more random access occasions. The operations of 2525 may be performed in accordance with examples as disclosed herein. In some aspects, aspects of the operations of 2525 may be performed by a random access message component 1730 as described with reference to FIG. 17.

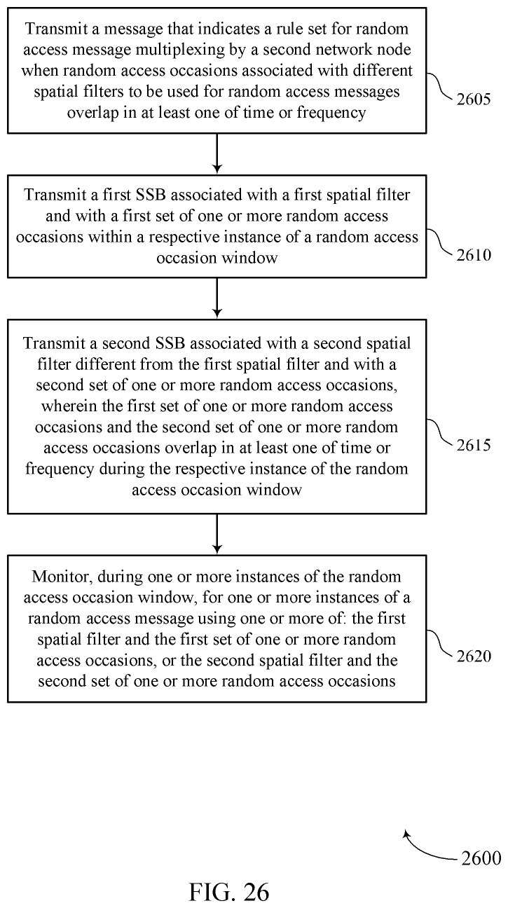

FIG. 26 shows a flowchart illustrating a method 2600 that supports multiplexing random access transmissions with different spatial filters in accordance with one or more aspects of the present disclosure. The operations of the method 2600 may be implemented by a network entity or a network node or its components as described herein. For example, the operations of the method 2600 may be performed by a network node as described with reference to FIGS. 1 through 14 and 19 through 22. In some aspects, a network node may execute a set of instructions to control the functional elements of the network node to perform the described functions. Additionally, or alternatively, the network node may perform aspects of the described functions using special-purpose hardware.

At 2605, the method may include transmitting a message that indicates a rule set for random access message multiplexing by a second network node when random access occasions associated with different spatial filters to be used for random access messages overlap in at least one of time or frequency. The operations of 2605 may be performed in accordance with examples as disclosed herein. In some aspects, aspects of the operations of 2605 may be performed by a random access multiplexing component 2125 as described with reference to FIG. 21.

At 2610, the method may include transmitting a first SSB associated with a first spatial filter and with a first set of one or more random access occasions within a respective instance of a random access occasion window. The operations of 2610 may be performed in accordance with examples as disclosed herein. In some aspects, aspects of the operations of 2610 may be performed by an SSB processing component 2130 as described with reference to FIG. 21.

At 2615, the method may include transmitting a second SSB associated with a second spatial filter different from the first spatial filter and with a second set of one or more random access occasions, where the first set of one or more random access occasions and the second set of one or more random access occasions overlap in at least one of time or frequency during the respective instance of the random access occasion window. The operations of 2615 may be performed in accordance with examples as disclosed herein. In some aspects, aspects of the operations of 2615 may be performed by an SSB processing component 2130 as described with reference to FIG. 21.

At 2620, the method may include monitoring, during one or more instances of the random access occasion window, for one or more instances of a random access message using one or more of: the first spatial filter and the first set of one or more random access occasions, or the second spatial filter and the second set of one or more random access occasions. The operations of 2620 may be performed in accordance with examples as disclosed herein. In some aspects, aspects of the operations of 2620 may be performed by a random access message component 2135 as described with reference to FIG. 21.

The following provides an overview of aspects of the present disclosure:

Aspect 1: A method of wireless communication performed by a network node, comprising: receiving a first SSB associated with a first spatial filter and with a first set of one or more random access occasions within a respective instance of a random access occasion window; receiving a second SSB associated with a second spatial filter different from the first spatial filter and with a second set of one or more random access occasions, wherein the first set of one or more random access occasions and the second set of one or more random access occasions overlap in at least one of time or frequency during the respective instance of the random access occasion window; transmitting, during a first instance of the random access occasion window, one or more first instances of a random access message using the first spatial filter and the first set of one or more random access occasions; and transmitting, during one or more additional instances of the random access occasion window, one or more additional instances of the random access message using, based on a rule set for random access message multiplexing when random access occasions associated with different spatial filters to be used for random access message transmissions overlap in at least one of time or frequency, one or more of: the first spatial filter and the first set of one or more random access occasions; or the second spatial filter and the second set of one or more random access occasions.

Aspect 2: The method of aspect 1, wherein transmitting the one or more additional instances of the random access message comprises: transmitting the one or more additional instances of the random access message using the first spatial filter and the first set of one or more random access occasions based on the rule set, wherein the rule set is that each instance of the random access message is to be transmitted using a same spatial filter.

Aspect 3: The method of aspect 1, wherein transmitting the one or more additional instances of the random access message comprises: transmitting the one or more additional instances of the random access message using at least the second spatial filter and at least the second set of one or more random access occasions based on the rule set, wherein the rule set is that different instances of the random access message are to be transmitted using different spatial filters.

Aspect 4: The method of aspect 3, further comprising: multiplexing, in accordance with a TDM pattern specified by the rule set, transmissions of the one or more first instances of the random access message using the first spatial filter with the one or more additional instances of the random access message using the first spatial filter and the second spatial filter.

Aspect 5: The method of any of aspects 1 through 4, wherein transmitting the one or more additional instances of the random access message continues until a sum of a first quantity of the one or more first instances of the random access message associated with the first spatial filter and a second quantity of the one or more additional instances of the random access message associated with the second spatial filter equals a total quantity.

Aspect 6: The method of aspect 5, further comprising: receiving a message that indicates the first quantity and the second quantity, wherein the message comprises an RRC message or a SIB.

Aspect 7: The method of aspect 5, further comprising: receiving a message that indicates the total quantity, wherein the message comprises an RRC message or a SIB.

Aspect 8: The method of any of aspects 5 through 7, wherein: transmitting the one or more first instances of the random access message comprises transmitting, in accordance with the rule set, the first quantity of the one or more first instances of the random access message associated with the first spatial filter; and transmitting the one or more additional instances of the random access message comprises transmitting, in accordance with the rule set, the second quantity of the one or more additional instances of the random access message associated with the second spatial filter after transmission of the first quantity of the one or more first instances of the random access message.

Aspect 9: The method of any of aspects 5 through 7, wherein: transmitting the one or more first instances of the random access message comprises transmitting, in accordance with an interleaving pattern specified by the rule set, the first quantity of instances of the random access message associated with the first spatial filter; and transmitting the one or more additional instances of the random access message comprises transmitting, in accordance with the interleaving pattern specified by the rule set, the second quantity of the one or more additional instances of the random access message associated with the second spatial filter, the one or more additional instances of the random access message interleaved with the one or more first instances of the random access message in time based on interleaving pattern.

Aspect 10: The method of any of aspects 5 through 9, wherein the first quantity equals the second quantity.

Aspect 11: The method of any of aspects 5 through 9, wherein the first quantity and the second quantity are different.

Aspect 12: The method of any of aspects 5 through 11, further comprising: receiving a message that indicates the rule set and a pattern specified by the rule set, the pattern comprising a random access message multiplexing pattern for transmitting the first quantity of instances of the random access message associated with the first spatial filter and the second quantity of instances of the random access message associated with the second spatial filter, wherein the message comprises an RRC message or a SIB.

Aspect 13: The method of any of aspects 1 through 12, wherein transmitting the one or more first instances of the random access message comprises: transmitting the one or more first instances of the random access message using the first spatial filter and the first set of one or more random access occasions based on a selection of the first spatial filter from a plurality of spatial filters comprising at least the first spatial filter and the second spatial filter based on a measurement of the first SSB, based on the rule set, or both.

Aspect 14: The method of any of aspects 1 through 13, wherein the first set of one or more random access occasions and the second set of one or more random access occasions overlap partially or fully in at least one of time or frequency during the respective instance of the random access occasion window.

Aspect 15: A method of wireless communication performed by a first network node, comprising: transmitting a message that indicates a rule set for random access message multiplexing by a second network node when random access occasions associated with different spatial filters to be used for random access messages overlap in at least one of time or frequency; transmitting a first SSB associated with a first spatial filter and with a first set of one or more random access occasions within a respective instance of a random access occasion window; transmitting a second SSB associated with a second spatial filter different from the first spatial filter and with a second set of one or more random access occasions, wherein the first set of one or more random access occasions and the second set of one or more random access occasions overlap in at least one of time or frequency during the respective instance of the random access occasion window; and monitoring, during one or more instances of the random access occasion window, for one or more instances of a random access message using one or more of: the first spatial filter and the first set of one or more random access occasions; or the second spatial filter and the second set of one or more random access occasions.

Aspect 16: The method of aspect 15, wherein transmitting the message comprises: transmitting an indication of the rule set for random access multiplexing to be performed by the second network node, wherein the rule set is that the second network node transmits each instance of the random access message using a same spatial filter.

Aspect 17: The method of aspect 15, wherein transmitting the message comprises: transmitting an indication of the rule set for random access multiplexing to be performed by the second network node, wherein the rule set is that the second network node transmits instances of the random access message using different spatial filters.

Aspect 18: The method of aspect 17, wherein the rule set indicates a TDM pattern for multiplexing transmissions of the one or more instances of the random access message using the first spatial filter and the second spatial filter.

Aspect 19: The method of any of aspects 15 through 18, wherein transmitting the message comprises: transmitting an indication of a parameter for random access multiplexing, wherein the parameter indicates a first quantity of instances of the random access message associated with the first spatial filter and a second quantity of instances of the random access message associated with the second spatial filter.

Aspect 20: The method of aspect 19, wherein the first quantity equals the second quantity.

Aspect 21: The method of aspect 19, wherein the first quantity and the second quantity are different.

Aspect 22: The method of any of aspects 15 through 21, wherein transmitting the message comprises: transmitting an indication of a parameter for random access multiplexing, wherein the parameter indicates a total quantity of the one or more instances of the random access message for a plurality of spatial filters comprising at least the first spatial filter and the second spatial filter.

Aspect 23: The method of any of aspects 15 through 22, wherein transmitting the message comprises: transmitting an indication of the rule set for random access multiplexing by the second network node, wherein the rule set is that the second network node transmits a first quantity of instances of the random access message associated with the first spatial filter and a second quantity of instances of the random access message associated with the second spatial filter after transmitting the first quantity of instances of the random access message.

Aspect 24: The method of any of aspects 15 through 22, wherein transmitting the message comprises: transmitting an indication of the rule set for random access multiplexing by the second network node, wherein the rule set is that the second network node transmits a first quantity of instances of the random access message associated with the first spatial filter and a second quantity of instances of the random access message associated with the second spatial filter in accordance with an interleaving pattern specified by the rule set.

Aspect 25: The method of any of aspects 15 through 24, wherein transmitting the message comprises: transmitting an RRC message or a SIB that indicates the rule set for random access message multiplexing when random access occasions associated with different spatial filters to be used for random access messages overlap partially or fully in at least one of time or frequency.

Aspect 26: A network node for wireless communication, comprising: a memory; and at least one processor coupled to the memory, wherein the at least one processor is configured to perform a method of any of aspects 1 through 14.

Aspect 27: An apparatus comprising at least one means for performing a method of any of aspects 1 through 14.

Aspect 28: A non-transitory computer-readable medium storing code the code comprising instructions executable by a processor to perform a method of any of aspects 1 through 14.

Aspect 29: A first network node for wireless communication, comprising: a memory; and at least one processor coupled to the memory, wherein the at least one processor is configured to perform a method of any of aspects 15 through 25.

Aspect 30: An apparatus comprising at least one means for performing a method of any of aspects 15 through 25.

Aspect 31: A non-transitory computer-readable medium storing code the code comprising instructions executable by a processor to perform a method of any of aspects 15 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network node for wireless communication, comprising:
a memory; and
at least one processor coupled to the memory, wherein the at least one processor is configured to:
receive a first synchronization signal block associated with a first spatial filter and with a first set of one or more random access occasions within a respective instance of a random access occasion window;
receive a second synchronization signal block associated with a second spatial filter different from the first spatial filter and with a second set of one or more random access occasions, wherein the first set of one or more random access occasions and the second set of one or more random access occasions overlap in at least one of time or frequency during the respective instance of the random access occasion window;
transmit, during a first instance of the random access occasion window, one or more first instances of a random access message using the first spatial filter and the first set of one or more random access occasions; and
transmit, during one or more additional instances of the random access occasion window, one or more additional instances of the random access message using, based on a rule set for random access message multiplexing when random access occasions associated with different spatial filters to be used for random access message transmissions overlap in at least one of time or frequency, one or more of:
the first spatial filter and the first set of one or more random access occasions; or
the second spatial filter and the second set of one or more random access occasions.

2. The network node of claim 1, wherein to transmit the one or more additional instances of the random access message, the at least one processor is configured to:
transmit the one or more additional instances of the random access message using the first spatial filter and the first set of one or more random access occasions based on the rule set, wherein the rule set is that each instance of the random access message is to be transmitted using a same spatial filter.

3. The network node of claim 1, wherein to transmit the one or more additional instances of the random access message, the at least one processor is configured to:
transmit the one or more additional instances of the random access message using at least the second spatial filter and at least the second set of one or more random access occasions based on the rule set, wherein the rule set is that different instances of the random access message are to be transmitted using different spatial filters.

4. The network node of claim 3, wherein the at least one processor is configured to:
multiplex, in accordance with a time domain multiplexing pattern specified by the rule set, transmissions of the one or more first instances of the random access message using the first spatial filter with the one or more additional instances of the random access message using the first spatial filter and the second spatial filter.

5. The network node of claim 1, wherein to transmit the one or more additional instances of the random access message, the at least one processor is configured to:
transmit the one or more additional instances of the random access message until a sum of a first quantity of the one or more first instances of the random access message associated with the first spatial filter and a second quantity of the one or more additional instances of the random access message associated with the second spatial filter equals a total quantity.

6. The network node of claim 5, wherein the at least one processor is configured to:
receive a message that indicates the first quantity and the second quantity, wherein the message comprises a radio resource control message or a system information block.

7. The network node of claim 5, wherein the at least one processor is configured to:
receive a message that indicates the total quantity, wherein the message comprises a radio resource control message or a system information block.

8. The network node of claim 5, wherein:
to transmit the one or more first instances of the random access message, the at least one processor is configured to transmit, in accordance with the rule set, the first quantity of the one or more first instances of the random access message associated with the first spatial filter; and
to transmit the one or more additional instances of the random access message, the at least one processor is configured to transmit, in accordance with the rule set, the second quantity of the one or more additional instances of the random access message associated with the second spatial filter after transmission of the first quantity of the one or more first instances of the random access message.

9. The network node of claim 5, wherein:
to transmit the one or more first instances of the random access message, the at least one processor is configured to transmit, in accordance with an interleaving pattern specified by the rule set, the first quantity of instances of the random access message associated with the first spatial filter; and
to transmit the one or more additional instances of the random access message, the at least one processor is configured to transmit, in accordance with the interleaving pattern specified by the rule set, the second quantity of the one or more additional instances of the random access message associated with the second spatial filter, the one or more additional instances of the random access message interleaved with the one or more first instances of the random access message in time based on interleaving pattern.

10. The network node of claim 5, wherein the first quantity equals the second quantity.

11. The network node of claim 5, wherein the first quantity and the second quantity are different.

12. The network node of claim 5, wherein the at least one processor is configured to:
receive a message that indicates the rule set and a pattern specified by the rule set, the pattern comprising a random access message multiplexing pattern for transmit the first quantity of instances of the random access message associated with the first spatial filter and the second quantity of instances of the random access message associated with the second spatial filter, wherein the message comprises a radio resource control message or a system information block.

13. The network node of claim 1, wherein, to transmit the one or more first instances of the random access message, the at least one processor is configured to:
transmit the one or more first instances of the random access message using the first spatial filter and the first set of one or more random access occasions based on a selection of the first spatial filter from a plurality of spatial filters comprising at least the first spatial filter and the second spatial filter based on a measurement of the first synchronization signal block, based on the rule set, or both.

14. The network node of claim 1, wherein the first set of one or more random access occasions and the second set of one or more random access occasions overlap partially or fully in at least one of time or frequency during the respective instance of the random access occasion window.

15. A first network node for wireless communication, comprising:
a memory; and
at least one processor coupled to the memory, wherein the at least one processor is configured to:
transmit a message that indicates a rule set for random access message multiplexing by a second network node when random access occasions associated with different spatial filters to be used for random access messages overlap in at least one of time or frequency;
transmit a first synchronization signal block associated with a first spatial filter and with a first set of one or more random access occasions within a respective instance of a random access occasion window;
transmit a second synchronization signal block associated with a second spatial filter different from the first spatial filter and with a second set of one or more random access occasions, wherein the first set of one or more random access occasions and the second set of one or more random access occasions overlap in at least one of time or frequency during the respective instance of the random access occasion window; and
monitor, during one or more instances of the random access occasion window, for one or more instances of a random access message using one or more of:
the first spatial filter and the first set of one or more random access occasions; or
the second spatial filter and the second set of one or more random access occasions.

16. The first network node of claim 15, wherein, to transmit the message, the at least one processor is configured to:
transmit an indication of the rule set for random access multiplexing to be performed by the second network node, wherein the rule set is that the second network node transmits each instance of the random access message using a same spatial filter.

17. The first network node of claim 15, wherein, to transmit the message, the at least one processor is configured to:
transmit an indication of the rule set for random access multiplexing to be performed by the second network node, wherein the rule set is that the second network node transmits instances of the random access message using different spatial filters.

18. The first network node of claim 17, wherein the rule set indicates a time domain multiplexing pattern for multiplexing transmissions of the one or more instances of the random access message using the first spatial filter and the second spatial filter.

19. The first network node of claim 15, wherein, to transmit the message, the at least one processor is configured to:
transmit an indication of a parameter for random access multiplexing, wherein the parameter indicates a first quantity of instances of the random access message associated with the first spatial filter and a second quantity of instances of the random access message associated with the second spatial filter.

20. The first network node of claim 19, wherein the first quantity equals the second quantity.

21. The first network node of claim 19, wherein the first quantity and the second quantity are different.

22. The first network node of claim 15, wherein, to transmit the message, the at least one processor is configured to:
transmit an indication of a parameter for random access multiplexing, wherein the parameter indicates a total quantity of the one or more instances of the random access message for a plurality of spatial filters comprising at least the first spatial filter and the second spatial filter.

23. The first network node of claim 15, wherein, to transmit the message, the at least one processor is configured to:
transmit an indication of the rule set for random access multiplexing by the second network node, wherein the rule set is that the second network node transmits a first quantity of instances of the random access message associated with the first spatial filter and a second quantity of instances of the random access message associated with the second spatial filter after transmit the first quantity of instances of the random access message.

24. The first network node of claim 15, wherein, to transmit the message, the at least one processor is configured to:
transmit an indication of the rule set for random access multiplexing by the second network node, wherein the rule set is that the second network node transmits a first quantity of instances of the random access message associated with the first spatial filter and a second quantity of instances of the random access message associated with the second spatial filter in accordance with an interleaving pattern specified by the rule set.

25. The first network node of claim 15, wherein, to transmit the message, the at least one processor is configured to:
transmit a radio resource control message or a system information block that indicates the rule set for random access message multiplexing when random access occasions associated with different spatial filters to be used for random access messages overlap partially or fully in at least one of time or frequency.

26. A method of wireless communication performed by a network node, comprising:
receiving a first synchronization signal block associated with a first spatial filter and with a first set of one or more random access occasions within a respective instance of a random access occasion window;
receiving a second synchronization signal block associated with a second spatial filter different from the first spatial filter and with a second set of one or more random access occasions, wherein the first set of one or more random access occasions and the second set of one or more random access occasions overlap in at least one of time or frequency during the respective instance of the random access occasion window;
transmitting, during a first instance of the random access occasion window, one or more first instances of a random access message using the first spatial filter and the first set of one or more random access occasions; and
transmitting, during one or more additional instances of the random access occasion window, one or more additional instances of the random access message using, based on a rule set for random access message multiplexing when random access occasions associated with different spatial filters to be used for random access message transmissions overlap in at least one of time or frequency, one or more of:
the first spatial filter and the first set of one or more random access occasions; or
the second spatial filter and the second set of one or more random access occasions.

27. The method of claim 26, wherein transmitting the one or more additional instances of the random access message comprises:
transmitting the one or more additional instances of the random access message using the first spatial filter and the first set of one or more random access occasions based on the rule set, wherein the rule set is that each instance of the random access message is to be transmitted using a same spatial filter.

28. The method of claim 26, wherein transmitting the one or more additional instances of the random access message comprises:
transmitting the one or more additional instances of the random access message using at least the second spatial filter and at least the second set of one or more random access occasions based on the rule set, wherein the rule set is that different instances of the random access message are to be transmitted using different spatial filters.

29. A method of wireless communication performed by a first network node, comprising:
transmitting a message that indicates a rule set for random access message multiplexing by a second network node when random access occasions associated with different spatial filters to be used for random access messages overlap in at least one of time or frequency;
transmitting a first synchronization signal block associated with a first spatial filter and with a first set of one or more random access occasions within a respective instance of a random access occasion window;
transmitting a second synchronization signal block associated with a second spatial filter different from the first spatial filter and with a second set of one or more random access occasions, wherein the first set of one or more random access occasions and the second set of one or more random access occasions overlap in at least one of time or frequency during the respective instance of the random access occasion window; and
monitoring, during one or more instances of the random access occasion window, for one or more instances of a random access message using one or more of:
the first spatial filter and the first set of one or more random access occasions; or
the second spatial filter and the second set of one or more random access occasions.

30. The method of claim 29, wherein transmitting the message comprises:
transmitting an indication of the rule set for random access multiplexing to be performed by the second network node, wherein the rule set is that the second network node transmits each instance of the random access message using a same spatial filter.
